(19) United States
(12) Patent Application Publication
(10) Pub. No.: US 2022/0083544 A1
(43) Pub. Date: Mar. 17, 2022

(54) COMPUTER-READABLE RECORDING MEDIUM STORING INFORMATION PROCESSING PROGRAM, INFORMATION PROCESSING METHOD, AND INFORMATION PROCESSING DEVICE

(71) Applicant: FUJITSU LIMITED, Kawasaki-shi (JP)

(72) Inventors: Takuto Tsuji, Kawasaki (JP); Yui Noma, Kawasaki (JP); Yoshifumi Ujibashi, Kawasaki (JP); Koichi Onoue, Kawasaki (JP); Yoshiyuki Sakamaki, Kawasaki (JP)

(73) Assignee: FUJITSU LIMITED, Kawasaki-shi (JP)

(21) Appl. No.: 17/531,852

(22) Filed: Nov. 22, 2021

Related U.S. Application Data
(63) Continuation of application No. PCT/JP2019/022610, filed on Jun. 6, 2019.

(51) Int. Cl. G06F 16/2458; G06F 16/248

(52) U.S. Cl. CPC G06F 16/2465; G06F 16/248

(57) ABSTRACT

A non-transitory computer-readable recording medium stores an information processing program for causing a computer to execute processing including: acquiring a plurality of regular expressions that is able to be used to search for a portion to be processed from each piece of data of a data group that is generated on the basis of the data included in the data group and data that indicates a processing example of the data; calculating a likelihood of using each regular expression to process the data group on the basis of a portion that corresponds to each of the plurality of acquired regular expressions in each piece of the data of the data group; and outputting the calculated likelihood of each of the regular expressions.

### CROSS-REFERENCE TO RELATED APPLICATION

This application is a continuation application of International Application PCT/JP2019/022610 filed on Jun. 6, 2019 and designated the U.S., the entire contents of which are incorporated herein by reference.

### FIELD

The embodiment discussed herein is related to an information processing program, an information processing method, and an information processing device.

### BACKGROUND

Typically, there is a technique, referred to as programming by example (PBE), for estimating how to process input content so as to generate output content on the basis of input content and output content designated by a user and automatically generating a program that can generate the output content from the input content. This technique is applied to, for example, a case where it is estimated how to process original data so that processed data can be generated on the basis of original data and processed data designated by a user, and a program for processing a data group including the original data is automatically generated.

Japanese Laid-open Patent Publication No. 2015-28699, Japanese Laid-open Patent Publication No. 2007-58587, and International Publication Pamphlet No. WO 2015/114804 are disclosed as related art.

### SUMMARY

According to an aspect of the embodiments, a non-transitory computer-readable recording medium stores an information processing program for causing a computer to execute processing including: acquiring a plurality of regular expressions that is able to be used to search for a portion to be processed from each piece of data of a data group that is generated on the basis of the data included in the data group and data that indicates a processing example of the data; calculating a likelihood of using each regular expression to process the data group on the basis of a portion that corresponds to each of the plurality of acquired regular expressions in each piece of the data of the data group; and outputting the calculated likelihood of each of the regular expressions.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is an explanatory diagram illustrating an example of an information processing method according to an embodiment;

FIG. 2 is an explanatory diagram illustrating an example of an information processing system 200;

FIG. 3 is a block diagram illustrating a hardware configuration example of an information processing device 100;

FIG. 4 is a block diagram illustrating a hardware configuration example of a client device 201;

FIG. 5 is a block diagram illustrating an exemplary functional configuration of the information processing device 100;

FIG. 6 is a block diagram illustrating a specific exemplary functional configuration of the information processing device 100;

FIG. 7 is an explanatory diagram (part 1) illustrating an operation example of the information processing device 100;

FIG. 8 is an explanatory diagram (part 2) illustrating the operation example of the information processing device 100;

FIG. 9 is an explanatory diagram illustrating a flow of calculating a success degree of each regular expression;

FIG. 10 is an explanatory diagram (part 1) illustrating an example of calculating a record evaluation value;

FIG. 11 is an explanatory diagram (part 2) illustrating an example of calculating the record evaluation value;

FIG. 12 is an explanatory diagram illustrating a specific example of calculating a division number evaluation value;

FIG. 13 is an explanatory diagram illustrating a specific example of calculating a distance evaluation value;

FIG. 14 is an explanatory diagram illustrating a specific example of calculating a position evaluation value;

FIG. 15 is an explanatory diagram illustrating a specific example of calculating the record evaluation value and calculating the success degree;

FIG. 16 is an explanatory diagram (part 1) illustrating a specific example of calculating a success degree of another regular expression;

FIG. 17 is an explanatory diagram (part 2) illustrating a specific example of calculating the success degree of the another regular expression;

FIG. 18 is an explanatory diagram (part 3) illustrating a specific example of calculating the success degree of the another regular expression;

FIG. 19 is an explanatory diagram illustrating a display screen example of the client device 201;

FIG. 20 is a flowchart illustrating an example of a reception processing procedure;

FIG. 21 is a flowchart illustrating an example of an estimation processing procedure;

FIG. 22 is a flowchart illustrating an example of a success degree calculation processing procedure;

FIG. 23 is a flowchart illustrating an example of a first calculation processing procedure;

FIG. 24 is a flowchart illustrating an example of a second calculation processing procedure;

FIG. 25 is a flowchart illustrating an example of a third calculation processing procedure; and

FIG. 26 is a flowchart illustrating an example of a process processing procedure.

### DESCRIPTION OF EMBODIMENTS

There is related art, for example, that determines a regular expression that has a high degree at which the number of text portions that match respective multiple regular expressions in each piece of a plurality of pieces of document data in the plurality of regular expressions matches the number of desired text portions in each of the plurality of pieces of document data. Furthermore, for example, there is a technique for displaying a reliability of a context transmission source on the basis of a result of searching for whether or not a combination of an organization name and a phone number extracted from the input context exists in a white list database (DB) of an organization that is registered in advance. Furthermore, for example, there is a technique for searching for an URL similar to a malicious URL from an access log on the basis of a malicious uniform resource locator (URL) obtained from a malware analysis result and a feature amount of a network access in the past.

However, in the related art, it is difficult to determine what kind of regular expression is used to accurately specify a portion desired to be processed by a user in each piece of data of a data group. As a result, it is difficult to automatically generate a program that can process each piece of the data of the data group according to a user's intention.

In one aspect, an object of the present embodiment is to make it possible to determine what kind of regular expression is preferable to process a data group.

Hereinafter, embodiments of an information processing program, an information processing method, and an information processing device will be described in detail with reference to the drawings.

### Example of Information Processing Method According to Embodiment

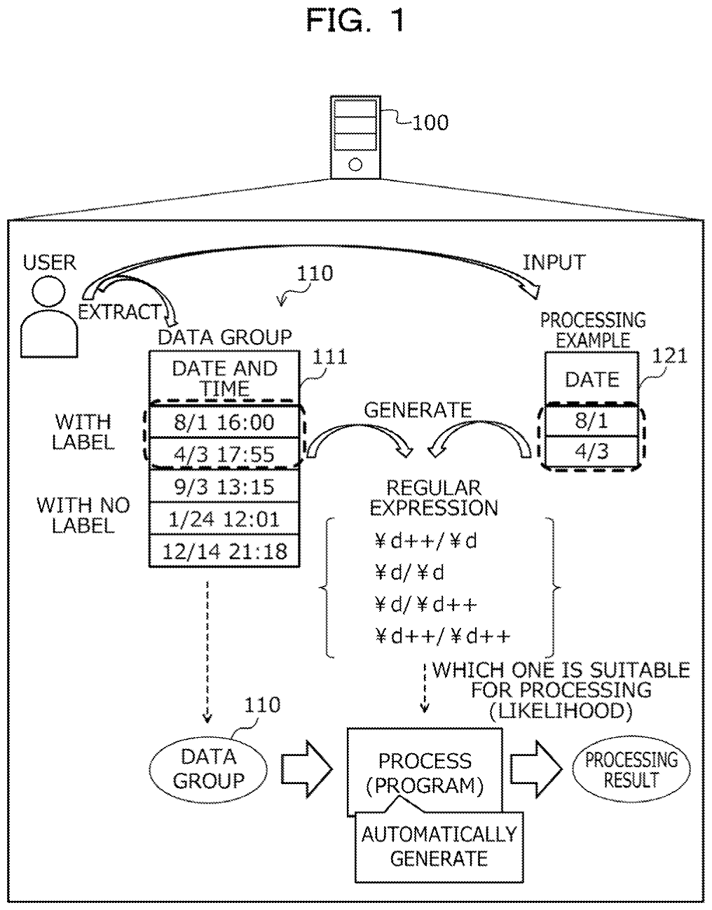

FIG. 1 is an explanatory diagram illustrating an example of an information processing method according to the embodiment. An information processing device 100 is a computer that can assist processing of each piece of data of a data group according to a user's intention.

The data group is a set of a plurality of pieces of data of the same type. The data group is, for example, a set of a plurality of pieces of data in the same format. The data is, for example, in a table format. The data processing includes, for example, extraction of some pieces of data, conversion of some pieces of data, division of data, or the like.

Here, a method is considered for automatically generating a program for processing a data group. In such a method, for example, it is estimated how to process original data so that processed data can be generated on the basis of original data and processed data designated by a user, and a program for processing a data group including the original data is automatically generated. Specifically, for example, the method estimates a regular expression that can specify a processed portion of the original data in a case where the original data is processed to the processed data and automatically generates a program using the estimated regular expression. Regarding the technique for estimating the regular expression, for example, the reference document 1 below can be referred.

Reference Document 1: Bartoli, Alberto, et al. “Inference of regular expressions for text extraction from examples.” IEEE Transactions on Knowledge and Data Engineering 28.5, 1217-1230, 2016

However, with such a method, there is a case where a plurality of regular expressions that can specify the processed portion in the original data exists, and it is not possible to determine which one of the regular expressions is a correct regular expression according to the user's intention. With such a method, for example, it is not possible to determine what kind of regular expression is used to correctly specify a portion desired to be processed by the user in each piece of the data of the data group. As a result, it is not possible to automatically generate a program that can process each piece of the data of the data group according to the user's intention.

Therefore, in the present embodiment, an information processing method will be described that can calculate a likelihood of each of the plurality of regular expressions on the basis of regularity that appears regarding the portion corresponding to each of the plurality of regular expressions in each piece of the data of the data group. According to this information processing method, a likelihood of each regular expression can be output, and it is possible to determine a regular expression suitable for the processing of the data group.

In FIG. 1, (1-1) the information processing device 100 acquires a plurality of regular expressions. The plurality of regular expressions can be used to search for a portion to be processed from each piece of the data of a data group 110. The plurality of regular expressions is generated, for example, on the basis of the data included in the data group 110 and data indicating a processing example of the data.

In the example in FIG. 1, the plurality of regular expressions is generated on the basis of a data set 111 designated by a user and included in the data group 110 and a data set 121 including a processing example of each piece of the data of the data set 111. The data set 121 includes processing examples obtained by extracting “ 8/1” and “ 4/3” from each piece of the data of the data set 111.

Therefore, as the plurality of regular expressions, specifically, for example, regular expressions “\d++/\d”, “\d/\d”, “\d/\d++”, and “\d++/\d++” that can specify “ 8/1”, “ 4/3”, or the like are considered. \d indicates one number. \d++ indicates n numbers. Specifically, for example, the information processing device 100 acquires the plurality of regular expressions “\d++/\d”, “\d/\d”,“\d/\d++”, and “\d++/\d++”.

(1-2) The information processing device 100 calculates a likelihood of each regular expression on the basis of a portion corresponding to each regular expression among the plurality of acquired regular expressions in each piece of the data of the data group 110. The likelihood is an index value indicating a likelihood of using a regular expression for processing of the data group 110. The likelihood is, for example, an index value that indicates how much a portion to be processed according to the user's intention can be specified when the data group 110 is processed.

Here, the data group 110 is a set of a plurality of pieces of data of the same type. The data group 110 is, for example, a set of a plurality of pieces of data in the same format. Furthermore, it is considered that a user intends to regularly process each piece of the data of the data group 110. Therefore, if the regular expression can specify the portion to be processed according to the user's intention, it is considered that regularity appears in the portions corresponding to the respective regular expressions in each piece of the data of the data group 110.

It is considered that, for example, the regularity appears in the number of pieces of partial data divided from each piece of the data of the data group 110 in a case where each piece of the data of the data group 110 is divided with reference to the portion corresponding to the regular expression for each regular expression. It is considered that, for example, the regularity appears in a position where the portion corresponding to the regular expression exists in each piece of the data of the data group 110 for each regular expression.

It is considered that, for example, the regularity appears in a similarity between pieces of partial data divided from two different pieces of data in a case where each piece of the data of the data group 110 is divided with reference to the portion corresponding to the regular expression for each regular expression. It is considered that the regularity appears in the number of portions corresponding to the regular expressions in each piece of the data of the data group 110 for each regular expression.

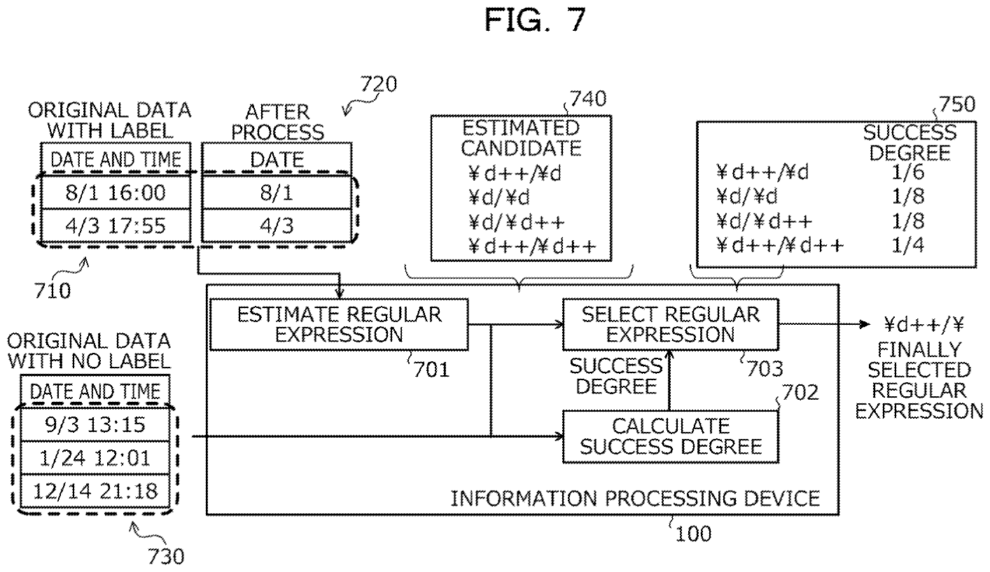

Therefore, the information processing device 100 calculates the likelihood of each regular expression using the regularity. In the example in FIG. 1, the information processing device 100 calculates a likelihood of each of the plurality of regular expressions “\d++/\d”, “\d/\d”, “\d/\d++”, and “\d++/\d++”. Specific examples in which the information processing device 100 calculates each likelihood will be described later, for example, with reference to FIGS. 7 to 18.

(1-3) The information processing device 100 outputs the calculated likelihood of each regular expression. The information processing device 100 stores, for example, the likelihood of each of the plurality of regular expressions “\d++/\d”,“\d/\d”,“\d/\d++”, and “\d++/\d++” in a storage unit.

This makes it possible for the information processing device 100 to determine which regular expression is preferable for the processing of the data group 110. Then, the information processing device 100 can process the data group 110 according to the user's intention using any one of regular expressions. Furthermore, the information processing device 100 may generate a program that can process the data group 110 according to the user's intention using any one of regular expressions.

Here, there may be a case where the information processing device 100 automatically generate the program for processing the data group 110 on the basis of the likelihood of each of the plurality of regular expressions. Furthermore, there may be a case where the information processing device 100 transmits the likelihood of each of the plurality of regular expressions to a device different from the information processing device 100 and makes the different device automatically generate the program for processing the data group 110.

(Example of Information Processing System 200)

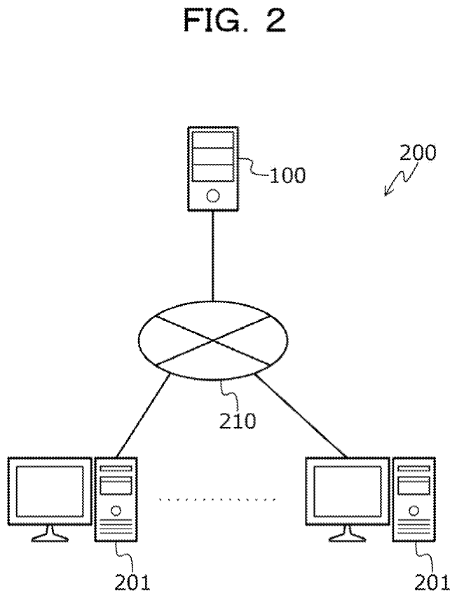

Next, an example of an information processing system 200 to which the information processing device 100 illustrated in FIG. 1 is applied will be described with reference to FIG. 2.

FIG. 2 is an explanatory diagram illustrating an example of the information processing system 200. In FIG. 2, the information processing system 200 includes the information processing device 100 and one or more client devices 201.

In the information processing system 200, the information processing device 100 and the client devices 201 are connected via a wired or wireless network 210. The network 210 is, for example, a local area network (LAN), a wide area network (WAN), the Internet, or the like.

The information processing device 100 stores a data group. The data group is, for example, input to the information processing device 100 via the client device 201 by a user of the information processing system 200. In the following description, there is a case where the user of the information processing system 200 is simply referred to as a “user”. The data group may be, for example, stored in the information processing device 100 in advance.

The information processing device 100 stores a plurality of regular expressions. The information processing device 100, for example, generates and stores a plurality of regular expressions that can be used to process a data group on the basis of one or more pieces of data included in the data group and data indicating a processing example of each of the one or more pieces of data. The one or more pieces of data is designated by the user via the client device 201, for example. The data indicating the processing example is input to the information processing device 100 by the user via the client device 201, for example. In the following description, there is a case where the data indicating the processing example is referred to as “processed data”.

The information processing device 100 calculates a likelihood of each of the plurality of regular expressions. The information processing device 100 processes the data group using any one of the plurality of regular expressions on the basis of the likelihood of each of the plurality of regular expressions. Furthermore, the information processing device 100 may generate a program for processing the data group using any one of the plurality of regular expressions on the basis of the likelihood of each of the plurality of regular expressions.

The information processing device 100 may display the likelihood of each of the plurality of regular expressions on the client device 201 and make the user select a regular expression used to generate the program. The information processing device 100 is, for example, a server, a personal computer (PC), or the like.

The client device 201 is a computer that can communicate with the information processing device 100. The client device 201 transmits the data group to the information processing device 100 on the basis of an operation input of the user. The client device 201 accepts designation of one or more pieces of data included in the data group on the basis of the operation input of the user and transmits to the information processing device 100 that the one or more pieces of data included in the data group are designated. The client device 201 may regard acceptance of inputs of the one or more pieces of data included in the data group as acceptance of the designation of the one or more pieces of data included in the data group. The client device 201 transmits data indicating a data processing example of each of the one or more designated pieces of data to the information processing device 100. Examples of the client device 201 include a PC, a tablet terminal, a smartphone, and the like.

As a result, the information processing system 200 provides a service for generating the program for processing the data group to the user. When the user makes the information processing device 100 acquire the data group and acquire the data indicating the data processing example of each of one or more pieces of data included in the data group via the client device 201, the user can acquire the program for processing the data group. Furthermore, the user can grasp the plurality of regular expressions and grasp which regular expression is suitable for the processing of the data group.

Here, a case has been described where the information processing device 100 is a device different from the client device 201. However, the embodiment is not limited to this. For example, there may be a case where the information processing device 100 can also operate as the client device 201. In this case, the information processing system 200 does not need to include the client device 201.

(Hardware Configuration Example of Information Processing Device 100)

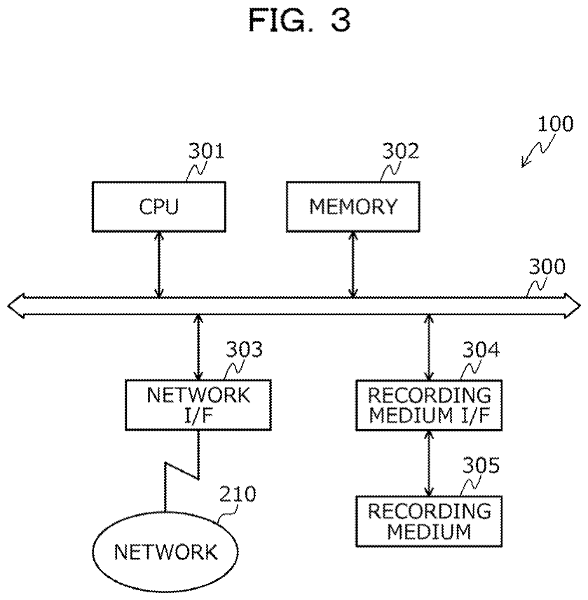

Next, a hardware configuration example of the information processing device 100 will be described with reference to FIG. 3.

FIG. 3 is a block diagram illustrating a hardware configuration example of the information processing device 100. In FIG. 3, the information processing device 100 includes a central processing unit (CPU) 301, a memory 302, a network interface (I/F) 303, a recording medium I/F 304, and a recording medium 305. Furthermore, individual components are connected to each other by a bus 300.

Here, the CPU 301 performs overall control of the information processing device 100. For example, the memory 302 includes a read only memory (ROM), a random access memory (RAM), a flash ROM, or the like. Specifically, for example, the flash ROM or the ROM stores various programs, and the RAM is used as a work area for the CPU 301. The programs stored in the memory 302 are loaded into the CPU 301 to cause the CPU 301 to execute coded processing.

The network I/F 303 is connected to the network 210 through a communication line and is connected to another computer via the network 210. Then, the network I/F 303 manages an interface between the network 210 and the inside and controls input and output of data to and from another computer. For example, the network I/F 303 is a modem, a LAN adapter, or the like.

The recording medium I/F 304 controls reading and writing of data from and to the recording medium 305 under the control of the CPU 301. For example, the recording medium I/F 304 is a disk drive, a solid state drive (SSD), a universal serial bus (USB) port, or the like. The recording medium 305 is a nonvolatile memory that stores data written under the control of the recording medium I/F 304. For example, the recording medium 305 is a disk, a semiconductor memory, a USB memory, or the like. The recording medium 305 may be attachable to and detachable from the information processing device 100.

For example, the information processing device 100 may include a keyboard, a mouse, a display, a printer, a scanner, a microphone, a speaker, or the like in addition to the components described above. Furthermore, the information processing device 100 may include a plurality of the recording medium I/Fs 304 and a plurality of the recording media 305. Furthermore, the information processing device 100 does not need to include the recording medium I/F 304 and the recording medium 305.

(Hardware Configuration Example of Client Device 201)

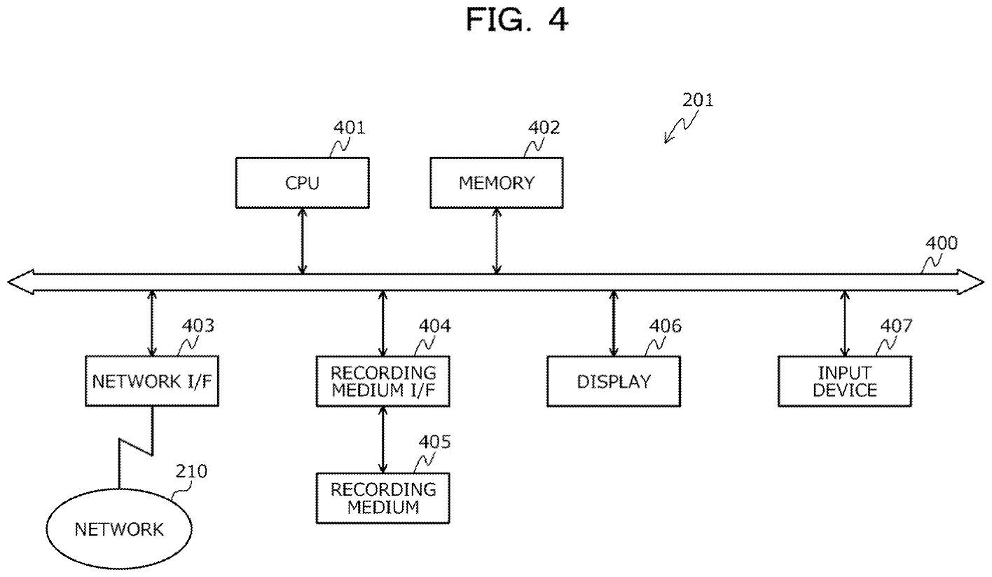

Next, a hardware configuration example of the client device 201 included in the information processing system 200 illustrated in FIG. 2 will be described with reference to FIG. 4.

FIG. 4 is a block diagram illustrating a hardware configuration example of the client device 201. In FIG. 4, the client device 201 includes a CPU 401, a memory 402, a network I/F 403, a recording medium I/F 404, a recording medium 405, a display 406, and an input device 407. Furthermore, the individual components are connected to each other by a bus 400.

Here, the CPU 401 performs overall control of the client device 201. For example, the memory 402 includes a ROM, a RAM, a flash ROM, and the like. Specifically, for example, the flash ROM or the ROM stores various programs, while the RAM is used as a work area for the CPU 401. The program stored in the memory 402 is loaded into the CPU 401 to cause the CPU 401 to execute coded processing.

The network I/F 403 is connected to the network 210 through a communication line, and is connected to another computer through the network 210. Then, the network I/F 403 manages an interface between the network 210 and the inside, and controls input and output of data to and from another computer. For example, the network I/F 403 is a modem, a LAN adapter, or the like.

The recording medium I/F 404 controls reading and writing of data from and to the recording medium 405 under the control of the CPU 401. The recording medium I/F 404 is, for example, a disk drive, an SSD, a USB port, or the like. The recording medium 405 is a nonvolatile memory that stores data written under the control of the recording medium I/F 404. For example, the recording medium 405 is a disk, a semiconductor memory, a USB memory, or the like. The recording medium 405 may be attachable to and detachable from the client device 201.

The display 406 displays data such as a document, an image, or function information, as well as a cursor, an icon, or a tool box. The display 406 is, for example, a cathode ray tube (CRT), a liquid crystal display, an organic electroluminescence (EL) display, or the like. The input device 407 includes keys to input characters, numbers, various instructions, or the like and inputs data. The input device 407 may be a keyboard, a mouse, or the like or may be a touch-panel input pad, a numeric keypad, or the like.

The client device 201 may include, for example, a printer, a scanner, a microphone, a speaker, and the like, in addition to the components described above. Furthermore, the client device 201 may include a plurality of the recording medium I/Fs 404 and a plurality of the recording media 405. Furthermore, the client device 201 does not need to include the recording medium I/F 404 and the recording medium 405.

(Exemplary Functional Configuration of Information Processing Device 100)

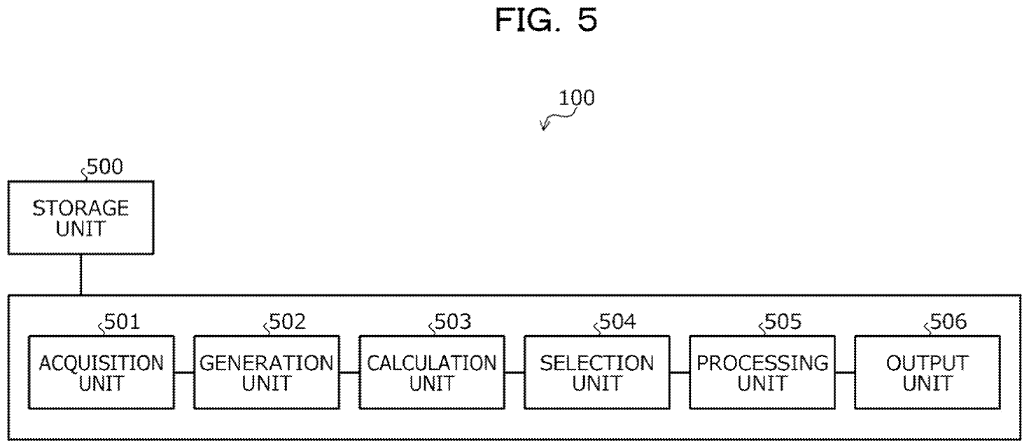

Next, an exemplary functional configuration of the information processing device 100 will be described with reference to FIG. 5.

FIG. 5 is a block diagram illustrating an exemplary functional configuration of the information processing device 100. The information processing device 100 includes a storage unit 500, an acquisition unit 501, a generation unit 502, a calculation unit 503, a selection unit 504, a processing unit 505, and an output unit 506.

For example, the storage unit 500 is implemented by a storage region such as the memory 302 or the recording medium 305 illustrated in FIG. 3. Hereinafter, a case where the storage unit 500 is included in the information processing device 100 will be described. However, the storage unit 500 is not limited to this case. For example, there may be a case where the storage unit 500 is included in a device different from the information processing device 100, and the information processing device 100 is allowed to refer to the content stored in the storage unit 500.

The acquisition unit 501 to the output unit 506 function as examples of a control unit. Specifically, for example, the acquisition unit 501 to the output unit 506 implement functions thereof by causing the CPU 301 to execute a program stored in the storage region such as the memory 302 or the recording medium 305 illustrated in FIG. 3, or by the network I/F 303. A processing result of each functional unit is stored in the storage region such as the memory 302 or the recording medium 305 illustrated in FIG. 3, for example.

The storage unit 500 stores various types of information to be referred or updated in the processing of each functional unit. The storage unit 500 stores, for example, a data group. The data group is a set of a plurality of pieces of data of the same type. The data group is, for example, a set of a plurality of pieces of data in the same format. The data is, for example, in a table format. The data group is, for example, stored in the storage unit 500 in response to the acquisition by the acquisition unit 501.

The storage unit 500 stores, for example, a plurality of regular expressions. The plurality of regular expressions can be used to search for a portion to be processed from each piece of data of a data group. The plurality of regular expressions is generated, for example, on the basis of the data included in the data group and processed data indicating a processing example of the data. The plurality of regular expressions is generated, specifically, for example, on the basis of one or more pieces of data included in the data group and the processed data indicating the data processing example of each of the one or more pieces of data. The plurality of regular expressions is stored in the storage unit 500, for example, in response to being acquired by the acquisition unit 501 or to being generated by the generation unit 502.

The storage unit 500 stores, for example, processed data used when the plurality of regular expressions is generated. Specifically, for example, the storage unit 500 stores the processed data indicating the data processing example in association with the data included in the data group. The storage unit 500 stores the processed data indicating the data processing example in association with each of the one or more pieces of data included in the data group. The processed data is stored in the storage unit 500, for example, in response to the acquisition by the acquisition unit 501.

The acquisition unit 501 acquires various types of information to be used for the processing of each functional unit. The acquisition unit 501 stores the various types of acquired information in the storage unit 500 or outputs the various types of acquired information to each functional unit. Furthermore, the acquisition unit 501 may output various types of information stored in the storage unit 500 to each functional unit. The acquisition unit 501 acquires various types of information, for example, on the basis of an operation input of a user of the information processing device 100. The acquisition unit 501 may receive various types of information, for example, from a device different from the information processing device 100.

The acquisition unit 501 acquires a data group. The acquisition unit 501, for example, receives the data group from the client device 201. The acquisition unit 501 accepts designation of data included in the data group. The acquisition unit 501 accepts the designation of the data included in the data group from the user via the client device 201 in response to that the output unit 506 displays the data group on the client device 201. The acquisition unit 501 accepts, for example, designation of one or more pieces of data included in the data group. The acquisition unit 501 may accept the designation, for example, by receiving the one or more pieces of data included in the data group from the client device 201.

The acquisition unit 501 acquires processed data indicating a processing example of the designated data. For example, the acquisition unit 501 receives the processed data indicating the data processing example in association with each of the one or more pieces of data included in the data group from the client device 201. In a case where the information processing device 100 does not generate the plurality of regular expressions, the acquisition unit 501 may acquire the plurality of regular expressions. The acquisition unit 501 receives, for example, the plurality of regular expressions from a device different from the information processing device 100. In this case, the information processing device 100 does not need to include the generation unit 502.

The generation unit 502 generates a plurality of regular expressions. The generation unit 502 generates the plurality of regular expressions on the basis of the designated data included in the data group and the processed data indicating the processing example of the designated data. The generation unit 502 generates the plurality of regular expressions, for example, on the basis of the one or more pieces of designated data included in the data group and the processed data indicating the data processing example of each of the one or more pieces of the designated data.

Specifically, for example, the generation unit 502 specifies a portion to be processed in the designated data on the basis of the designated data and the processed data indicating the processing example of the designated data and generates the plurality of regular expressions that can specify the portion to be processed in the designated data. As a result, the generation unit 502 can generate the plurality of regular expressions to be a candidate used for the processing of the data group and can make the calculation unit 503 calculate a likelihood of each regular expression.

Furthermore, the generation unit 502 may generate processing content. The processing content indicates how to process the portion to be processed in each piece of the data of the data group searched using the regular expression. The generation unit 502 generates the processing content on the basis of the designated data included in the data group and the processed data indicating the processing example of the designated data. The generation unit 502 generates the processing content, for example, on the basis of the one or more pieces of designated data included in the data group and the processed data indicating the data processing example of each of the one or more pieces of the designated data. As a result, the generation unit 502 can make the processing unit 505 refer to the processing content.

The calculation unit 503 calculates a likelihood of each regular expression. The likelihood is an index value indicating a likelihood of using a regular expression for processing of the data group. The likelihood is, for example, an index value that indicates how much a portion to be processed can be specified according to the user's intention when the data group is processed. The value of the likelihood increases as predetermined regularity appears regarding the portion corresponding to the regular expression in each piece of the data of the data group, and the likelihood means that the regular expression can specify the portion to be processed from each piece of the data of the data group according to the user's intention. Specifically, for example, the likelihood is a success degree to be described later with reference to FIGS. 7 to 18.

The calculation unit 503 calculates the likelihood of the regular expression on the basis of the portion corresponding to the regular expression in each piece of the data of the data group for each of the plurality of acquired regular expressions. For example, the calculation unit 503 calculates the likelihood of the regular expression on the basis of the number of pieces of partial data divided from each piece of the data of the data group in a case where each piece of the data of the data group is divided with reference to the portion corresponding to the regular expression, for each regular expression.

Here, for example, if the regular expression is according to the user's intention, it is considered that the number of pieces of partial data divided from each piece of the data of the data group tends to be the same.

Therefore, specifically, for example, the calculation unit 503 calculates the likelihood of the regular expression so that the likelihood is larger as dispersion of the number of pieces of partial data divided from each piece of the data of the data group with reference to the portion corresponding to the regular expression is smaller, for each regular expression. As a result, the calculation unit 503 can obtain the likelihood to be an index used to determine whether or not the data group can be processed according to the user's intention according to which one of regular expressions and can make the selection unit 504 refer to the likelihood.

Here, for example, the regular expression is generated on the basis of processed data, reflecting the user's intention, corresponding to each of the one or more pieces of designated data. Therefore, for each regular expression, the number of pieces of partial data divided from each of the one or more pieces of designated data in a case where each of the one or more pieces of designated data is divided with reference to the portion corresponding to the regular expression may be a reference indicating the user's intention.

Therefore, specifically, for example, for each regular expression, the calculation unit 503 compares the number of pieces of partial data divided from each of the one or more pieces of data and the number of pieces of partial data divided from each of remaining data excluding the one or more pieces of data included in the data group. Then, the calculation unit 503 calculates a likelihood of each regular expression on the basis of the comparison result.

More specifically, for example, for each regular expression, the calculation unit 503 calculates a difference between the number of pieces of partial data divided from each of the one or more pieces of data and the number of pieces of partial data divided from each of the remaining data excluding the one or more pieces of data included in the data group. Then, the calculation unit 503 calculates the likelihood of the regular expression so that the likelihood increases as the calculated difference is smaller for each regular expression.

More specifically, for example, the calculation unit 503 may calculate a difference absolute value of the number of pieces of partial data divided from each of the one or more pieces of data and the number of pieces of partial data divided from each of the remaining data, for each regular expression. Then, the calculation unit 503 calculates the likelihood of the regular expression so that the likelihood increases as the calculated difference absolute value is smaller for each regular expression.

Furthermore, more specifically, for example, the calculation unit 503 may calculate a statistical value of the difference absolute value of the number of pieces of partial data divided from each of the remaining data and the number of pieces of partial data divided from each of the one or more pieces of data, for each regular expression. The statistical value is a minimum value, a maximum value, an average value, a mode value, or the like. Then, the calculation unit 503 calculates the likelihood of the regular expression so that the likelihood increases as the calculated statistical value of the difference absolute value is smaller for each regular expression. As a result, the calculation unit 503 can obtain the likelihood to be an index used to determine whether or not the data group can be processed according to the user's intention according to which one of regular expressions and can make the selection unit 504 refer to the likelihood.

The calculation unit 503 calculates the likelihood of the regular expression on the basis of a similarity between pieces of partial data divided from two different pieces of data in a case where each piece of the data of the data group is divided with reference to the portion corresponding to the regular expression, for each regular expression. The calculation unit 503 calculates the likelihood of the regular expression on the basis of a similarity between first partial data and second partial data selected from among the pieces of partial data divided from each piece of the data of the data group with reference to the portion corresponding to the regular expression, for example, for each regular expression.

It is preferable that a position of the first partial data and a position of the second partial data have, for example, a correspondence relationship. The correspondence relationship means, for example, which number of partial data from the beginning corresponds. Specifically, for example, the correspondence relationship means that relative positions with respect to the portion corresponding to the regular expression are common. The similarity is expressed by an editing distance between the first partial data and the second partial data.

Here, for example, it is considered that, if the regular expression is according to the user's intention, the similarity between the pieces of the partial data divided from the two different pieces of data with reference to the portion corresponding to the regular expression tends to increase.

Therefore, specifically, for example, the calculation unit 503 calculates the likelihood of the regular expression so that the likelihood is larger as the similarity between the pieces of the partial data divided from the two different pieces of data with reference to the portion corresponding to the regular expression is larger, for each regular expression. As a result, the calculation unit 503 can obtain the likelihood to be an index used to determine whether or not the data group can be processed according to the user's intention according to which one of regular expressions and can make the selection unit 504 refer to the likelihood.

Here, for example, the regular expression is generated on the basis of processed data, reflecting the user's intention, corresponding to each of the one or more pieces of designated data. Therefore, for each regular expression, the pieces of partial data divided from each of the one or more pieces of designated data in a case where each of the one or more pieces of designated data is divided with reference to the portion corresponding to the regular expression may be a reference indicating the user's intention.

Therefore, specifically, for example, the calculation unit 503 selects the first partial data from among the pieces of the partial data divided from each of the one or more pieces of designated data for each regular expression. The calculation unit 503 selects the second partial data that exists at a position corresponding to the first partial data from among the pieces of the partial data divided from each piece of the remaining data excluding the one or more pieces of data included in the data group for each regular expression. The calculation unit 503 calculates the likelihood of the regular expression on the basis of the similarity between the selected first partial data and second partial data for each regular expression.

More specifically, for example, the calculation unit 503 calculates the likelihood of the regular expression so that the likelihood increases as the similarity between the selected first partial data and second partial data is larger, for each regular expression.

Furthermore, more specifically, for example, there may be a case where the calculation unit 503 selects the plurality of pieces of second partial data and selects one or more pieces of first partial data corresponding to each second partial data for each regular expression. In this case, the calculation unit 503 calculates the similarity between each selected second partial data and each first partial data corresponding to the second partial data for each regular expression and calculates a statistical value of the similarity. The statistical value is a minimum value, a maximum value, an average value, a mode value, or the like. Then, the calculation unit 503 calculates the likelihood of the regular expression so that the likelihood increases as the calculated statistical value of the similarity is larger, for each regular expression. As a result, the calculation unit 503 can obtain the likelihood to be an index used to determine whether or not the data group can be processed according to the user's intention according to which one of regular expressions and can make the selection unit 504 refer to the likelihood.

The calculation unit 503 calculates the likelihood of the regular expression on the basis of the position where the portion corresponding to the regular expression exists in each piece of the data of the data group, for each regular expression. The position indicates, for example, what number of character in the data the beginning of the portion corresponding to the regular expression is.

Here, for example, it is considered that, if the regular expression is according to the user's intention, the position where the portion corresponding to the regular expression exists in each piece of the data of the data group tends to be the same.

Therefore, specifically, for example, the calculation unit 503 calculates the likelihood of the regular expression so that the likelihood increases as the dispersion of the position where the portion corresponding to the regular expression exists in each piece of the data of the data group is smaller, for each regular expression. As a result, the calculation unit 503 can obtain the likelihood to be an index used to determine whether or not the data group can be processed according to the user's intention according to which one of regular expressions and can make the selection unit 504 refer to the likelihood.

Here, for example, the regular expression is generated on the basis of processed data, reflecting the user's intention, corresponding to each of the one or more pieces of designated data. Therefore, for each regular expression, the position where the portion corresponding to the regular expression exists in each of the one or more pieces of designated data may be the reference indicating the user's intention.

Therefore, specifically, for example, the calculation unit 503 specifies the position where the portion corresponding to the regular expression exists in each of the one or more pieces of data, for each regular expression. For each regular expression, the calculation unit 503 specifies the position where the portion corresponding to the regular expression exists in each piece of the remaining data excluding the one or more pieces of data included in the data group. The calculation unit 503 calculates the likelihood of the regular expression on the basis of the result of comparing the specified positions for each regular expression.

More specifically, for example, the calculation unit 503 calculates a difference between the specified positions for each regular expression. Then, the calculation unit 503 calculates the likelihood of the regular expression so that the likelihood increases as the calculated difference is smaller for each regular expression.

More specifically, for example, the calculation unit 503 may calculate a difference absolute value between the specified positions for each regular expression. Then, the calculation unit 503 calculates the likelihood of the regular expression so that the likelihood increases as the calculated difference absolute value is smaller for each regular expression.

Furthermore, more specifically, for example, the calculation unit 503 may calculate a statistical value of the difference absolute value between the position specified in each piece of the remaining data and the position specified in each of one or more pieces of data, for each regular expression. The statistical value is a minimum value, a maximum value, an average value, a mode value, or the like. Then, the calculation unit 503 calculates the likelihood of the regular expression so that the likelihood increases as the calculated statistical value of the difference absolute value is smaller for each regular expression. As a result, the calculation unit 503 can obtain the likelihood to be an index used to determine whether or not the data group can be processed according to the user's intention according to which one of regular expressions and can make the selection unit 504 refer to the likelihood.

The calculation unit 503 calculates the likelihood of the regular expression on the basis of the number of portions corresponding to the regular expression in each piece of the data of the data group for each regular expression.

Here, for example, it is considered that, if the regular expression is according to the user's intention, the number of portions corresponding to the regular expression in each piece of the data of the data group tends to be the same.

Therefore, specifically, for example, the calculation unit 503 calculates the likelihood of the regular expression so that the likelihood increases as the dispersion of the number of portions corresponding to the regular expression in each piece of the data of the data group is smaller, for each regular expression. As a result, the calculation unit 503 can obtain the likelihood to be an index used to determine whether or not the data group can be processed according to the user's intention according to which one of regular expressions and can make the selection unit 504 refer to the likelihood.

Here, for example, the regular expression is generated on the basis of processed data, reflecting the user's intention, corresponding to each of the one or more pieces of designated data. Therefore, for each regular expression, the number of portions corresponding to the regular expression in each piece of the one or more pieces of designated data may be the reference indicating the user's intention.

Therefore, specifically, for example, the calculation unit 503 calculates the number of portions corresponding to the regular expression in each of the one or more pieces of data for each regular expression. The calculation unit 503 calculates the number of portions corresponding to the regular expression in each piece of the remaining data excluding the one or more pieces of data included in the data group, for each regular expression. The calculation unit 503 calculates the likelihood of the regular expression on the basis of the difference between the number of calculated pieces of data of the one or more pieces of data and the number of calculated pieces of data of the remaining data for each regular expression.

More specifically, for example, the calculation unit 503 calculates the likelihood of the regular expression so that the likelihood increases as the difference is smaller, for each regular expression. As a result, the calculation unit 503 can obtain the likelihood to be an index used to determine whether or not the data group can be processed according to the user's intention according to which one of regular expressions and can make the selection unit 504 refer to the likelihood.

The selection unit 504 selects one of the plurality of regular expressions. The selection unit 504 selects one of the plurality of regular expressions on the basis of the calculated likelihood of each regular expression, for example. Specifically, for example, the selection unit 504 selects a regular expression having the largest likelihood. Specifically, for example, the selection unit 504 may select one of one or more regular expressions of which a likelihood is equal to or more than a threshold. Specifically, for example, the selection unit 504 may select one or more regular expressions from the first to a predetermined rank in a descending order of the likelihood. As a result, the selection unit 504 can output the regular expression that is determined to be able to process the data group according to the user's intention to the processing unit 505. Therefore, the selection unit 504 can improve a probability that the processing unit 505 processes the data group according to the user's intention.

The selection unit 504 may accept the selection of one of the plurality of regular expressions. For example, the selection unit 504 accepts the selection of any one of regular expressions from the user via the client device 201 in response to that the display unit displays the likelihood of each regular expression on the client device 201. As a result, the selection unit 504 can output the regular expression that is determined to be able to process the data group according to the user's intention to the processing unit 505. Therefore, the selection unit 504 can improve a probability that the processing unit 505 processes the data group according to the user's intention.

The processing unit 505 processes the data group. The processing unit 505 processes the data group using the selected one of the regular expressions. The processing unit 505 processes the data group, for example, on the basis of the selected one of the regular expressions and the processing content generated by the generation unit 502. As a result, the processing unit 505 can process the data group and reduce a work amount of a user than a case where the user manually processes the data group.

The processing unit 505 may generate a program for processing the data group. The processing unit 505 generates the program for processing the data group using the selected one of the regular expressions. For example, the processing unit 505 generates the program for processing the data group on the basis of the selected one of the regular expressions and the processing content generated by the generation unit 502. As a result, the processing unit 505 can provide the program for processing the data group to the user.

The output unit 506 outputs various types of information. An output format is, for example, display on a display, print output to a printer, transmission to an external device by the network I/F 303, or storage in the storage region such as the memory 302 or the recording medium 305. The output unit 506 outputs, for example, a data group. Specifically, for example, the output unit 506 transmits and displays the data group to and on the client device 201. As a result, the output unit 506 can make the user refer to the data group and make it easy for the user to create the processed data.

The output unit 506 outputs a processing result of any one of functional units. As a result, the output unit 506 can notify the user of the information processing system 200 of the processing result of each functional unit and can improve convenience of the information processing system 200.

The output unit 506 outputs the calculated likelihood of each regular expression. For example, the output unit 506 associates each regular expression with the likelihood of the regular expression and transmits and displays the regular expression and the likelihood to and on the client device 201. As a result, the output unit 506 can make the user refer to the likelihood of each regular expression and make it easier for the user to select the regular expression used to process the data group.

The output unit 506 outputs a result of processing the data group. For example, the output unit 506 transmits and displays the result of processing the data group to and on the client device 201. As a result, the output unit 506 can make the user refer to the result of processing the data group.

The output unit 506 may output the program for processing the data group. The output unit 506 transmits the program for processing the data group to the client device 201. As a result, the output unit 506 can make the program for processing the data group be available for the user. Then, the output unit 506 can reduce a work amount when the user processes the data group. Furthermore, the output unit 506 can divert the program when the user processes another data group that is the same type as the data group and can reduce the work amount of the user.

(Specific Exemplary Functional Configuration of Information Processing Device 100)

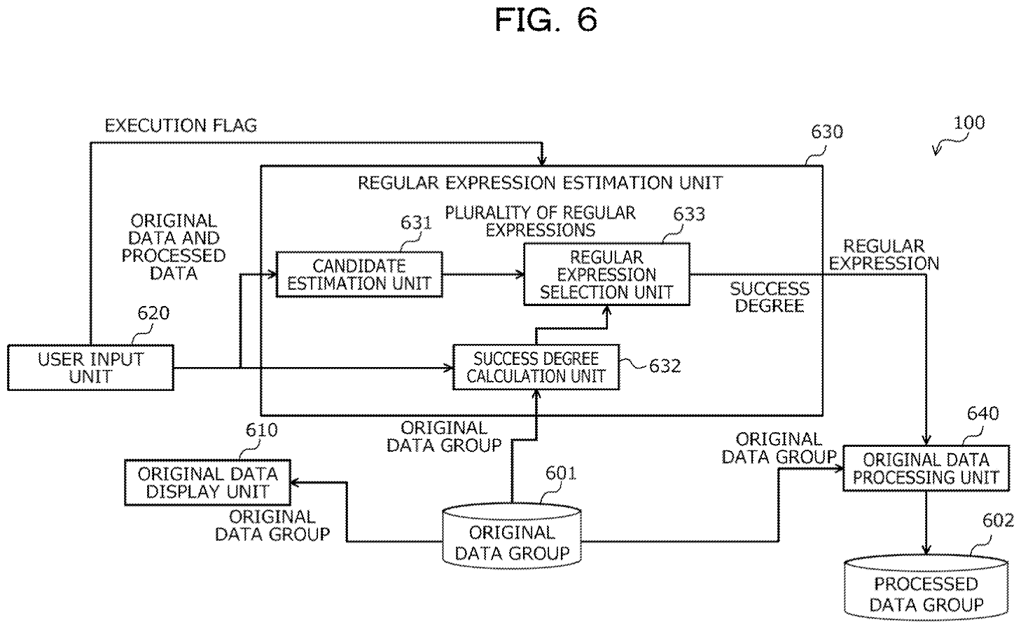

Next, a specific exemplary functional configuration of the information processing device 100 will be described with reference to FIG. 6.

FIG. 6 is a block diagram illustrating a specific exemplary functional configuration of the information processing device 100. The information processing device 100 includes an original data display unit 610, a user input unit 620, a regular expression estimation unit 630, and an original data processing unit 640. The regular expression estimation unit 630 includes a candidate estimation unit 631, a success degree calculation unit 632, and a regular expression selection unit 633.

The original data display unit 610 to the original data processing unit 640 implement, for example, the acquisition unit 501 to the output unit 506 illustrated in FIG. 5. Specifically, for example, the original data display unit 610 to the original data processing unit 640 implement functions thereof by causing the CPU 301 to execute a program stored in the storage region such as the memory 302 or the recording medium 305 illustrated in FIG. 3, or by the network I/F 303. A processing result of each functional unit is stored in the storage region such as the memory 302 or the recording medium 305 illustrated in FIG. 3, for example.

The original data display unit 610 reads an original data group 601 and displays the read original data group 601 on the client device 201. The user input unit 620 accepts designation of any one of original data of the original data group 601 and an input of the processed data indicating the processing example of processing the designated original data from the client device 201 and accepts an estimation instruction. The user input unit 620 sets an execution flag of the regular expression estimation unit 630 to be valid in response to the estimation instruction, outputs the designated original data and the input processed data to the regular expression estimation unit 630, and makes the regular expression estimation unit 630 generate the plurality of regular expressions.

In a case where the execution flag is valid, the regular expression estimation unit 630 reads the designated original data and the input processed data and generates the plurality of regular expressions. The candidate estimation unit 631 estimates a plurality of regular expressions to be candidates used to process the original data group 601 on the basis of the designated original data and the input processed data and outputs the estimated regular expressions to the success degree calculation unit 632. The success degree calculation unit 632 calculates a success degree of each of the plurality of regular expressions on the basis of the original data group 601 and outputs the calculated success degree to the regular expression selection unit 633. The regular expression selection unit 633 selects any one of the plurality of regular expressions to be candidates on the basis of the success degree of each regular expression, outputs the selected regular expression to the original data processing unit 640, and makes the original data processing unit 640 process the original data group 601.

The original data processing unit 640 processes the original data group 601 using the regular expression. The original data processing unit 640 outputs a processed data group 602 obtained by processing the original data group 601.

(Operation Example of Information Processing Device 100)

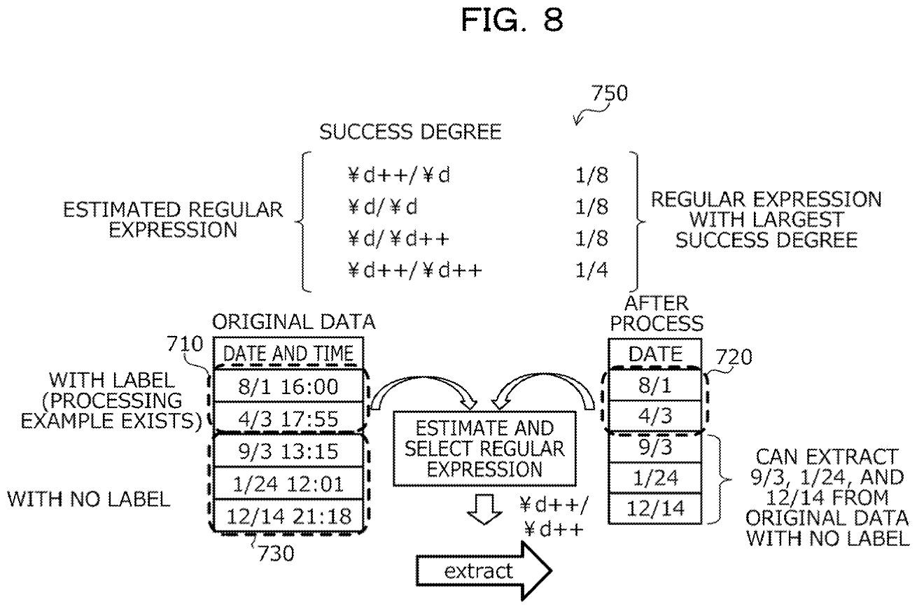

Next, an operation example of the information processing device 100 will be described with reference to FIGS. 7 and 8.

FIGS. 7 and 8 are explanatory diagrams illustrating an operation example of the information processing device 100. In FIG. 7, the information processing device 100 accepts an original data group. The original data group includes, for example, original data 710. The information processing device 100 accepts processed data 720 corresponding to the original data 710 created by the user.

In the following description, there is a case where the original data 710 of which the processed data 720 exists is referred to as “labeled original data 710”. Furthermore, the original data group includes original data 730. In the example in FIG. 7, processed data corresponding to the original data 730 does not exist. In the following description, there is a case where the original data 730 of which processed data does not exist is referred to as “original data 730 with no label”.

As indicated by a numeral reference 701, the information processing device 100 generates the plurality of regular expressions to be candidates used to process the original data group on the basis of the original data 710 and the processed data 720. The plurality of regular expressions is, for example, regular expressions indicated in a table 740.

As indicated by a numeral reference 702, the information processing device 100 calculates a success degree of each of the plurality of regular expressions on the basis of the original data group. The value of the success degree increases as a probability that processing according to the user's intention is performed is higher. The success degree of each regular expression is, for example, a success degree indicated in a table 750.

As indicated by a numeral reference 703, the information processing device 100 selects any one of the plurality of regular expressions as a regular expression used to process the data group on the basis of the success degree of each regular expression. The information processing device 100 selects, for example, a regular expression “ [symbol] d++/ [symbol] d++” having the largest success degree. Next, description of FIG. 8 will be made.

In FIG. 8, the information processing device 100 processes the original data 730 with no label using the selected regular expression “ [symbol] d++/ [symbol] d++” having the largest success degree. As a result, the information processing device 100 can process the original data 730 with no label using processing content similar to that when the labeled original data 710 is processed to the processed data 720. The information processing device 100 can perform processing for extracting “ 9/3”, “ 1/24”, “ 12/14”, or the like, for example, from the original data 730 with no label.

(Flow of Calculating Success Degree of Each Regular Expression)

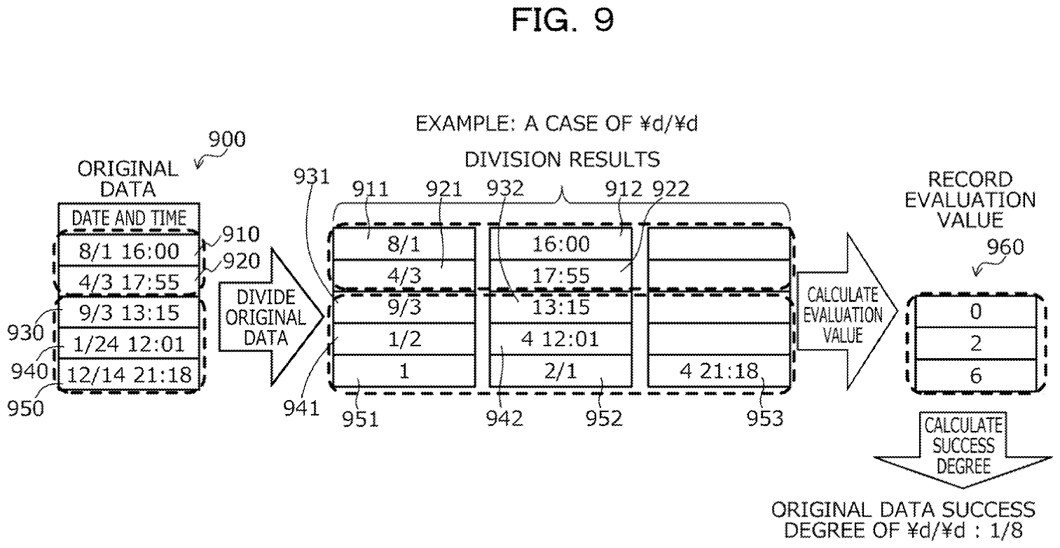

Next, a flow of calculating a success degree of each regular expression will be described with reference to FIG. 9.

FIG. 9 is an explanatory diagram illustrating the flow of calculating the success degree of each regular expression. In the example in FIG. 9, a case will be described where the information processing device 100 calculates a success degree of a regular expression “ [symbol] d/ [symbol] d”. In FIG. 9, the information processing device 100 stores an original data group 900.

The original data group 900 includes original data 910, 920, 930, 940, and 950. The original data 910 and 920 is labeled. The original data 930, 940, and 950 is unlabeled.

The information processing device 100 divides the original data 910, 920, 930, 940, and 950 with reference to a portion corresponding to the regular expression “ [symbol] d/ [symbol] d”. The original data 910 is divided into, for example, partial data 911 and partial data 912. The original data 920 is divided into, for example, partial data 921 and partial data 922. The original data 930 is divided into, for example, partial data 931 and partial data 932. The original data 940 is divided into, for example, partial data 941 and partial data 942. The original data 950 is divided into, for example, partial data 951, partial data 952, and partial data 953.

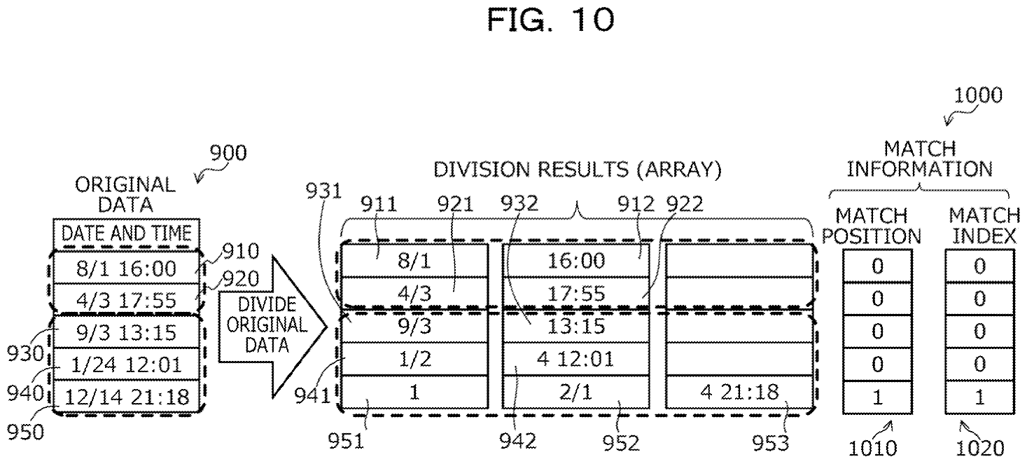

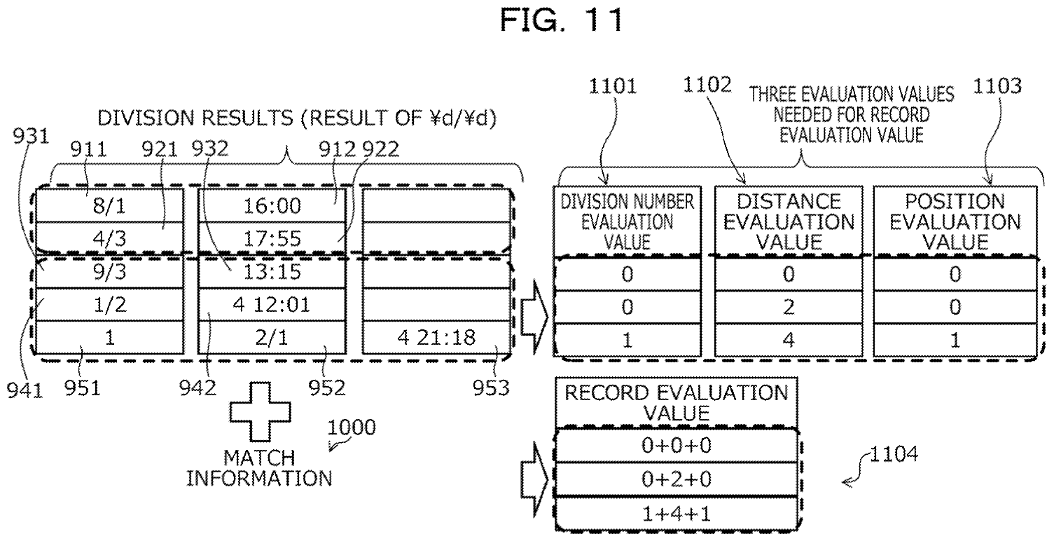

The information processing device 100 calculates record evaluation values “0”, “2”, and “6” respectively for the original data 930, 940, and 950 with no label on the basis of the division results as indicated in a table 960. The record evaluation value is a total evaluation value of a division number evaluation value, a distance evaluation value, and a position evaluation value. The total evaluation value of the division number evaluation value, the distance evaluation value, and the position evaluation value is calculated, for example, as described later with reference to FIGS. 10 and 11. The information processing device 100 calculates a reciprocal “⅛” of the sum of the record evaluation value as the success degree of the regular expression “ [symbol] d/ [symbol] d”.

(Example of Calculating Record Evaluation Value)

Next, an example in which the information processing device 100 calculates a record evaluation value will be described with reference to FIGS. 10 and 11.

FIGS. 10 and 11 are explanatory diagrams illustrating an example of calculating a record evaluation value. In FIG. 10, the information processing device 100 generates match information 1000 on the basis of the division results. The match information 1000 includes a match position array 1010 and a match index array 1020.

The match position array 1010 includes match positions of the original data 910, 920, 930, 940, and 950. The match position indicates at what number of character the beginning of the portion corresponding to the regular expression “ [symbol] d/ [symbol] d” is positioned in the original data 910, 920, 930, 940, and 950. In a case where the beginning of the portion corresponding to the regular expression “ [symbol] d/ [symbol] d” is positioned at an n-th character, a value of n−1 is set to the match position.

The match index array 1020 includes match indexes of the original data 910, 920, 930, 940, and 950. The match index indicates what number from the beginning the partial data including the portion corresponding to the regular expression “ [symbol] d/ [symbol] d” is positioned in the original data 910, 920, 930, 940, and 950. In a case where the partial data including the portion corresponding to the regular expression “ [symbol] d/ [symbol] d” is n-th partial data from the beginning, a value of n−1 is set to the match index. Next, the description of FIG. 11 will be made.

In FIG. 11, the information processing device 100 calculates the division number evaluation value, the distance evaluation value, and the position evaluation value corresponding to the original data 930, 940, and 950 with reference to the match information 1000 and on the basis of the division results.

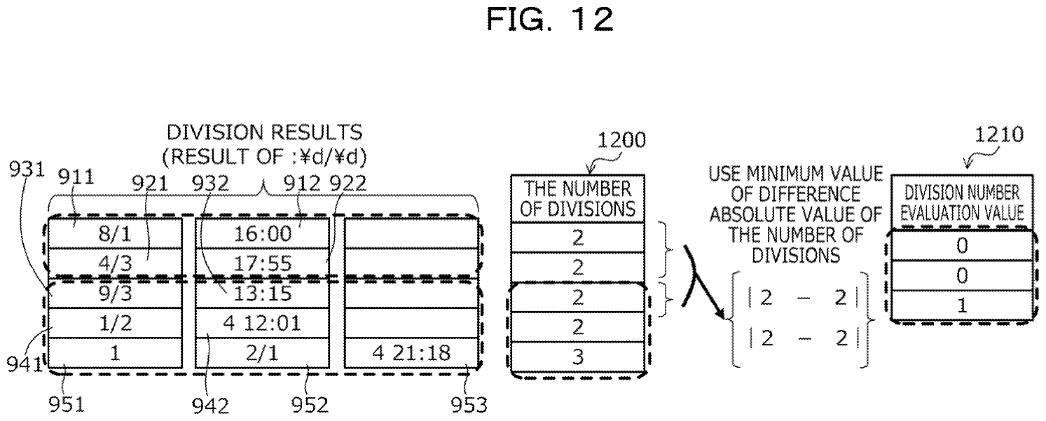

The division number evaluation value is an evaluation value indicating how much the number of divisions of the original data 930, 940, and 950 is different from the number of divisions of the original data 910 and 920. The number of divisions is the number of pieces of the partial data. The division number evaluation value is, for example, expressed by a difference absolute value of the number of divisions. The division number evaluation value corresponding to the original data 930, 940, and 950 is, for example, as indicated in a table 1101. A specific example in which the information processing device 100 calculates a division number evaluation value will be described later, for example, with reference to FIG. 12.

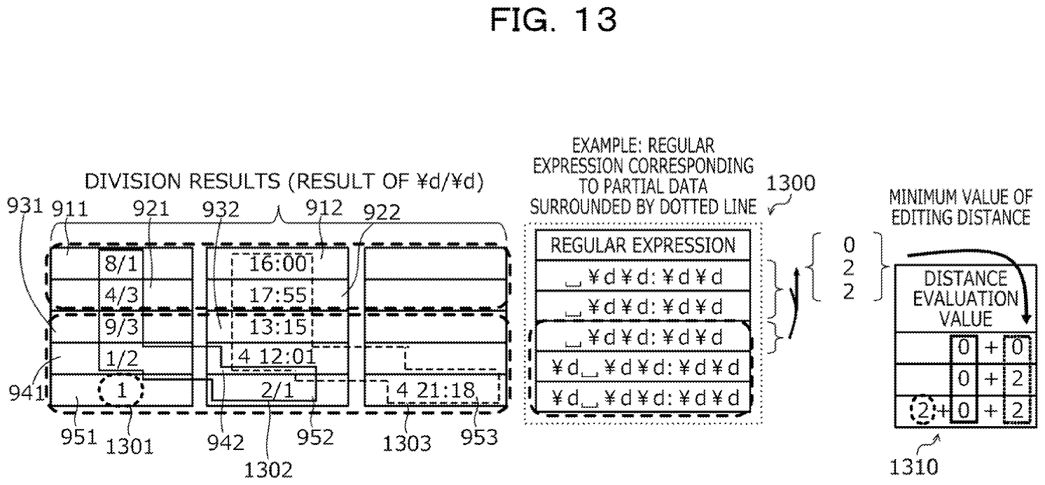

The distance evaluation value is an evaluation value indicating how much the partial data of the original data 930, 940, and 950 is different from the partial data of the original data 910 and 920 that exists at the position corresponding to the partial data. The distance evaluation value is expressed by an editing distance between the pieces of the partial data. The distance evaluation value corresponding to the original data 930, 940, and 950 is, for example, as indicated in a table 1102. A specific example in which the information processing device 100 calculates a distance evaluation value will be described later, for example, with reference to FIG. 13.

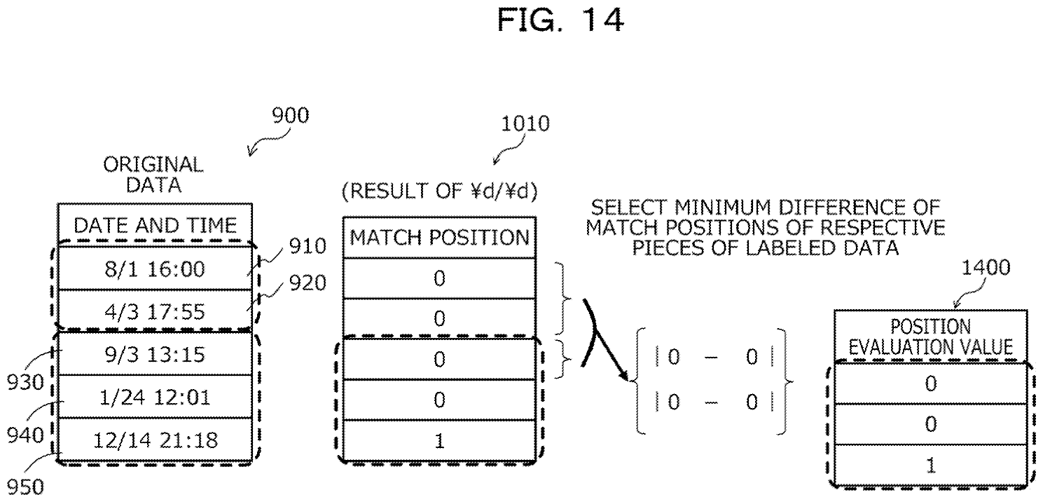

The position evaluation value is an evaluation value indicating how much the match position of the original data 930, 940, and 950 is different from the match position of the original data 910 and 920. The position evaluation value is expressed by a difference absolute value of the match positions. The position evaluation value corresponding to the original data 930, 940, and 950 is, for example, as indicated in a table 1103. A specific example in which the information processing device 100 calculates a position evaluation value will be described later, for example, with reference to FIG. 14.

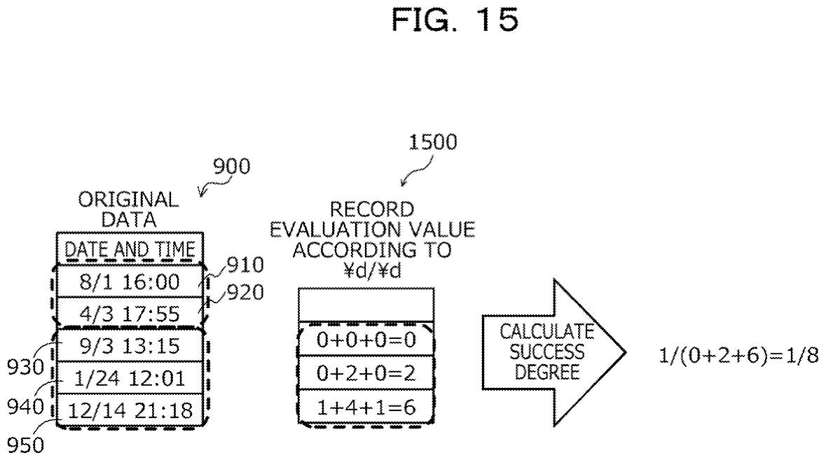

The information processing device 100 calculates a sum total of the division number evaluation value, the distance evaluation value, and the position evaluation value corresponding to the original data 930, 940, and 950 as the record evaluation value corresponding to the original data 930, 940, and 950. The record evaluation value corresponding to the original data 930, 940, and 950 is as indicated in a table 1104. A specific example in which the information processing device 100 calculates a record evaluation value will be described later, for example, with reference to FIG. 15.

(Specific Example of Calculating Record Evaluation Value and Calculating Success Degree)

Next, with reference to FIGS. 12 to 15, a specific example will be described in which the information processing device 100 calculates a division number evaluation value, a distance evaluation value, and a position evaluation value corresponding to the original data 930, 940, and 950, calculates a record evaluation value, and calculates a success degree for the regular expression “ [symbol] d/ [symbol] d”. First, the description of FIG. 12 will be made, and a specific example will be described in which the information processing device 100 calculates a division number evaluation value.

FIG. 12 is an explanatory diagram illustrating a specific example of calculating a division number evaluation value. In FIG. 12, the information processing device 100 calculates division numbers “2”, “2”, “2”, “2”, and “3” of the respective pieces of original data 910, 920, 930, 940, and 950 on the basis of the division results based on the regular expression “ [symbol] d/ [symbol] d”. The division numbers of the pieces of original data 910, 920, 930, 940, and 950 are, for example, as indicated in a table 1200.

The information processing device 100 calculates a minimum value of a difference absolute value of the division number of the original data 930 with no label and each of the division numbers of the labeled original data 910 and 920 as the division number evaluation value corresponding to the original data 930. The information processing device 100 calculates, for example, a division number evaluation value “0” of the original data 930. Similarly, the information processing device 100 calculates division number evaluation values “0” and “1” of the respective pieces of original data 940 and 950 with no label. The division number evaluation value corresponding to the original data 930, 940, and 950 is, for example, as indicated in a table 1210.

Here, a case has been described where the information processing device 100 uses the minimum value of the difference absolute value to calculate the division number evaluation value. However, the embodiment is not limited to this. For example, there may be a case where the information processing device 100 uses a statistical value of the difference absolute value other than the minimum value, in order to calculate the division number evaluation value. For example, the statistical value is an average value, a maximum value, a mode value, or the like. Next, description of FIG. 13 will be made, and a specific example will be described in which the information processing device 100 calculates a distance evaluation value.

FIG. 13 is an explanatory diagram illustrating a specific example of calculating a distance evaluation value. In FIG. 13, the information processing device 100 specifies a partial data group existing at the relatively same position with reference to the match index based on the regular expression “ [symbol] d/ [symbol] d”.

The information processing device 100 specifies, for example, a group 1301 of the partial data 951 alone. The information processing device 100 specifies, for example, a group 1302 of the pieces of partial data 911, 921, 931, 941, and 952. The information processing device 100 specifies, for example, a group 1303 of the pieces of partial data 912, 922, 932, 942, and 953.

The information processing device 100 replaces the pieces of partial data 912, 922, 932, 942, and 953 of the group 1303 with regular expressions. The regular expressions are, for example, as indicated in a table 1300. The information processing device 100 calculates the minimum editing distance “0” of the editing distances between the regular expression corresponding to the partial data 932 of the original data 930 with no label and the regular expressions corresponding to the pieces of partial data 912 and 922 of the labeled original data 910 and 920.

Similarly, the information processing device 100 calculates the minimum editing distances “2” and “2” respectively corresponding to the pieces of original data 940 and 950 with no label for the group 1303. Similarly, the information processing device 100 calculates the minimum editing distances “0”, “0”, and “0” respectively corresponding to the pieces of original data 930, 940, and 950 with no label for the group 1302.

The information processing device 100 replaces the partial data 951 of the group 1301 with a regular expression. Here, because the group 1301 does not include any one of the pieces of partial data 911, 912, 921, and 922 of the labeled original data 910 and 920, and sets the regular expression corresponding to the labeled original data 910 and 920 to “null”. The information processing device 100 calculates an editing distance “2” between the regular expression corresponding to the partial data 951 of the original data 950 with no label and “null”.

The information processing device 100 calculates the sums “0+0”, “0+2”, and “2+0+2” of the editing distances respectively corresponding to the pieces of original data 930, 940, and 950 with no label as the distance evaluation values. Here, a case has been described where the information processing device 100 uses the minimum editing distance to calculate the distance evaluation value. However, the embodiment is not limited to this. For example, there may be a case where the information processing device 100 uses a statistical value of the editing distance other than the minimum value in order to calculate the distance evaluation value. For example, the statistical value is an average value, a maximum value, a mode value, or the like. Next, description of FIG. 14 will be made, and a specific example will be described in which the information processing device 100 calculates a position evaluation value.

FIG. 14 is an explanatory diagram illustrating a specific example of calculating a position evaluation value. In FIG. 14, the information processing device 100 refers to the match position array 1010 based on the regular expression “ [symbol] d/ [symbol] d” and acquires the match position of the original data 930 with no label and the match positions of the respective pieces of labeled original data 910 and 920. The information processing device 100 calculates the minimum value of the difference absolute value between the match position of the original data 930 with no label and the match positions of the respective pieces of labeled original data 910 and 920 as the position evaluation value corresponding to the original data 930. The information processing device 100 calculates, for example, a match position evaluation value “0” of the original data 930.

Similarly, the information processing device 100 calculates position evaluation values “0” and “1” of the respective pieces of original data 940 and 950 with no label. The position evaluation value corresponding to the original data 930, 940, and 950 is, for example, as indicated in a table 1400. Here, a case has been described where the information processing device 100 uses the minimum value of the difference absolute value to calculate the position evaluation value. However, the embodiment is not limited to this. For example, there may be a case where the information processing device 100 uses a statistical value of the difference absolute value other than the minimum value, in order to calculate the position evaluation value. For example, the statistical value is an average value, a maximum value, a mode value, or the like. Next, description of FIG. 15 will be made, and a specific example will be described where the information processing device 100 calculates a record evaluation value on the basis of the division number evaluation value, the distance evaluation value, and the position evaluation value corresponding to the original data 930, 940, and 950 and calculates a success degree.

FIG. 15 is an explanatory diagram illustrating a specific example of calculating a record evaluation value and calculating a success degree. In FIG. 15, the information processing device 100 calculates a sum total “0” of a division number evaluation value “0”, a distance evaluation value “0”, and a position evaluation value “0” corresponding to the original data 930 as a record evaluation value “0” corresponding to the original data 930. Similarly, the information processing device 100 calculates record evaluation values “2” and “6” corresponding to the respective pieces of original data 940 and 950.

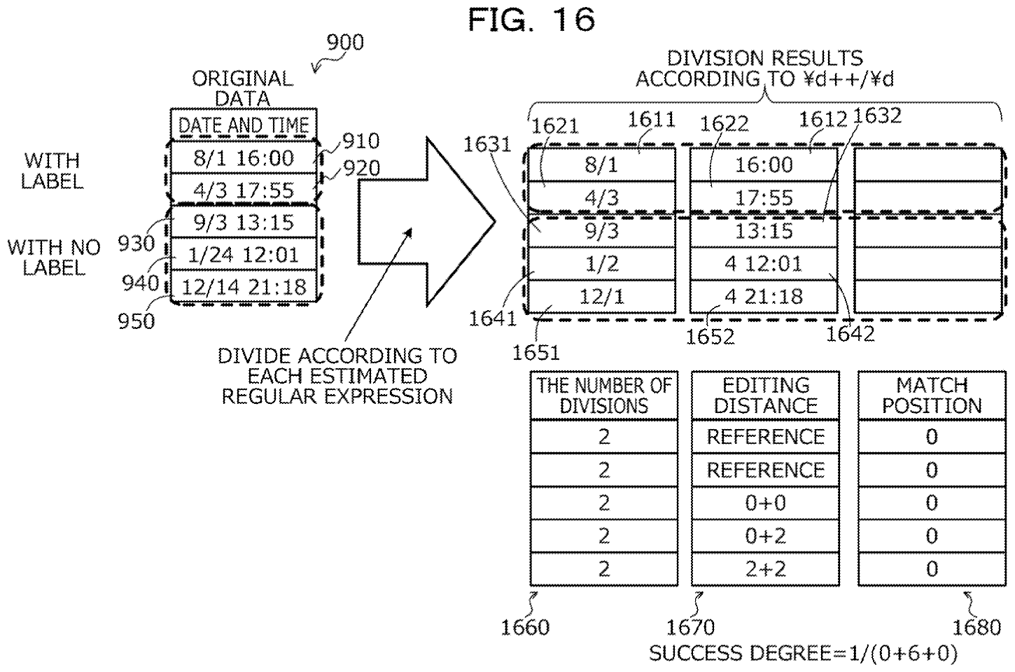

The information processing device 100 calculates a reciprocal “⅛” of the sum of the record evaluation values “0”, “2”, and “6” corresponding to the respective pieces of original data 930, 940, and 950 as a success degree “⅛” of the regular expression “ [symbol] d/ [symbol] d”. Next, description of FIGS. 16 to 18 will be made, and a specific example will be described in which the information processing device 100 calculates success degrees of the other regular expressions “ [symbol] d++/ [symbol] d”, “ [symbol] d/ [symbol] d++”, and “ [symbol] d++/ [symbol] d++”.

FIGS. 16 to 18 are explanatory diagrams illustrating a specific example of calculating success degrees of other regular expressions. In FIG. 16, the information processing device 100 divides the pieces of original data 910, 920, 930, 940, and 950 with reference to a portion corresponding to the regular expression “ [symbol] d++/ [symbol] d”. The original data 910 is divided into, for example, partial data 1611 and partial data 1612. The original data 920 is divided into, for example, partial data 1621 and partial data 1622. The original data 930 is divided into, for example, partial data 1631 and partial data 1632. The original data 940 is divided into, for example, partial data 1641 and partial data 1642. The original data 950 is divided into, for example, partial data 1651 and partial data 1652.

As in FIG. 12, the information processing device 100 calculates the number of divisions and calculates a division number evaluation value “0” on the basis of the division results based on the regular expression “ [symbol] d++/ [symbol] d”. The number of divisions is, for example, as indicated in a table 1660. Furthermore, as in FIG. 13, the information processing device 100 calculates an editing distance and a distance evaluation value “6” on the basis of the division results based on the regular expression “ [symbol] d++/ [symbol] d”. The editing distance is, for example, as indicated in a table 1670.

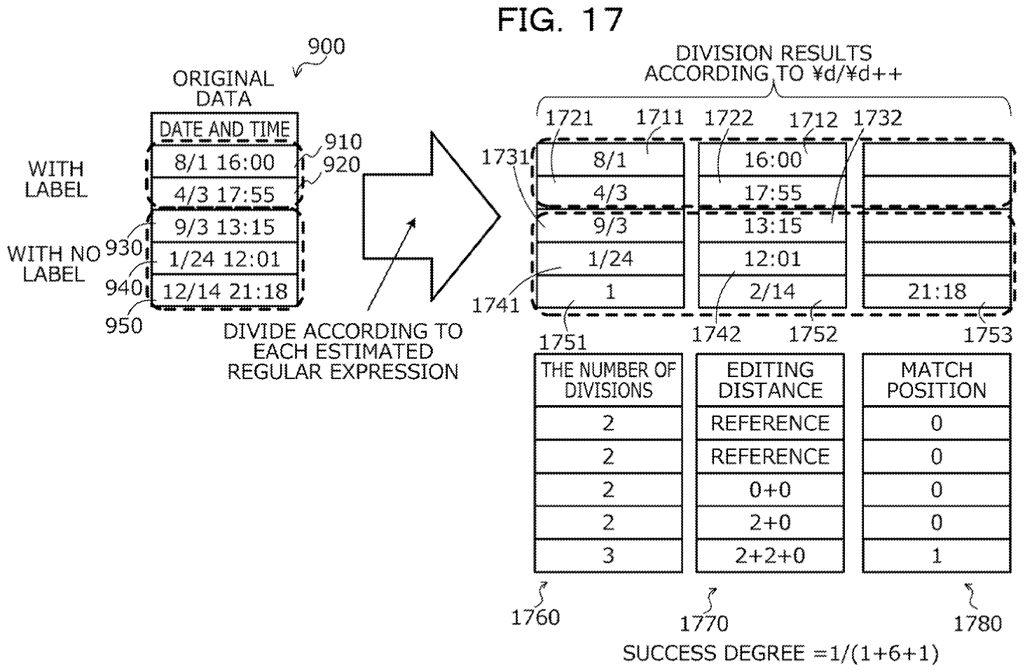

Furthermore, as in FIG. 14, the information processing device 100 refers to the match position and calculates a position evaluation value “0” on the basis of the division results based on the regular expression “ [symbol] d++/ [symbol] d”. The match position is, for example, as indicated in a table 1680. Furthermore, as in FIG. 15, the information processing device 100 calculates a success degree “⅙” of the regular expression “ [symbol] d++/ [symbol] d”. Next, description of FIG. 17 will be made.

In FIG. 17, the information processing device 100 divides the pieces of original data 910, 920, 930, 940, and 950 with reference to the portion corresponding to the regular expression “ [symbol] d/ [symbol] d++”. The original data 910 is divided into, for example, partial data 1711 and partial data 1712. The original data 920 is divided into, for example, partial data 1721 and partial data 1722. The original data 930 is divided into, for example, partial data 1731 and partial data 1732. The original data 940 is divided into, for example, partial data 1741 and partial data 1742. The original data 950 is divided into, for example, partial data 1751, partial data 1752, and partial data 1753.

As in FIG. 12, the information processing device 100 calculates the number of divisions and calculates a division number evaluation value “1” on the basis of the division results based on the regular expression “ [symbol] d/ [symbol] d++”. The number of divisions is, for example, as indicated in a table 1760. Furthermore, as in FIG. 13, the information processing device 100 calculates an editing distance and a distance evaluation value “6” on the basis of the division results based on the regular expression “ [symbol] d/ [symbol] d++”. The editing distance is, for example, as indicated in a table 1770.

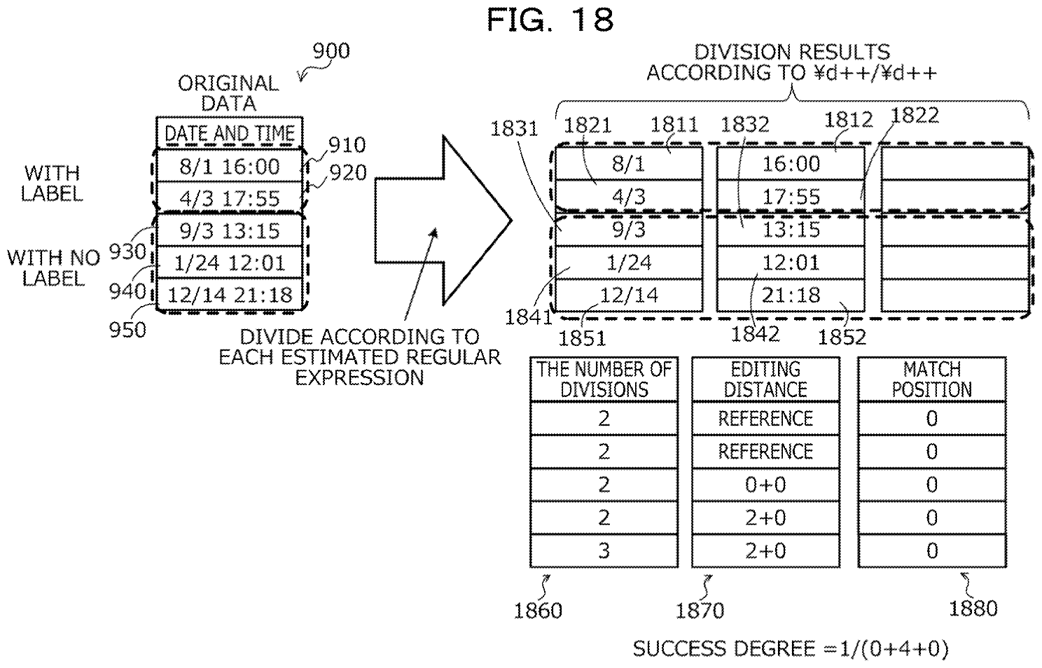

Furthermore, as in FIG. 14, the information processing device 100 refers to the match position and calculates a position evaluation value “1” on the basis of the division results based on the regular expression “ [symbol] d/ [symbol] d++”. The match position is, for example, as indicated in a table 1780. Furthermore, as in FIG. 15, the information processing device 100 calculates a success degree “⅛” of the regular expression “ [symbol] d/ [symbol] d++”. Next, description of FIG. 18 will be made.

In FIG. 18, the information processing device 100 divides the pieces of original data 910, 920, 930, 940, and 950 with reference to the portion corresponding to the regular expression “ [symbol] d++/ [symbol] d++”. The original data 910 is divided into, for example, partial data 1811 and partial data 1812. The original data 920 is divided into, for example, partial data 1821 and partial data 1822. The original data 930 is divided into, for example, partial data 1831 and partial data 1832. The original data 940 is divided into, for example, partial data 1841 and partial data 1842. The original data 950 is divided into, for example, partial data 1851 and partial data 1852.

As in FIG. 12, the information processing device 100 calculates the number of divisions and calculates a division number evaluation value “0” on the basis of the division results based on the regular expression “ [symbol] d++/ [symbol] d++”. The number of divisions is, for example, as indicated in a table 1860. Furthermore, as in FIG. 13, the information processing device 100 calculates an editing distance and a distance evaluation value “4” on the basis of the division results based on the regular expression “ [symbol] d++/ [symbol] d++”. The editing distance is, for example, as indicated in a table 1870.

Furthermore, as in FIG. 14, the information processing device 100 refers to the match position and calculates a position evaluation value “0” on the basis of the division results based on the regular expression “ [symbol] d++/ [symbol] d++”. The match position is, for example, as indicated in a table 1880. Furthermore, as in FIG. 15, the information processing device 100 calculates a success degree “¼” of the regular expression “ [symbol] d++/ [symbol] d++”. As a result, the information processing device 100 can calculate a success degree of each regular expression to be an index used to determine which regular expression is preferable for the processing on the original data group 900.

Then, the information processing device 100 can easily determine which one of the regular expressions is used to process the original data group 900 by the user so that the original data group 900 can be processed according to the user's intention on the basis of the success degree of each regular expression. For example, the information processing device 100 can display the success degree of each regular expression on the client device 201 and make the user grasp the success degree of each regular expression. Therefore, the user can easily process the original data group 900 and can reduce a work amount.

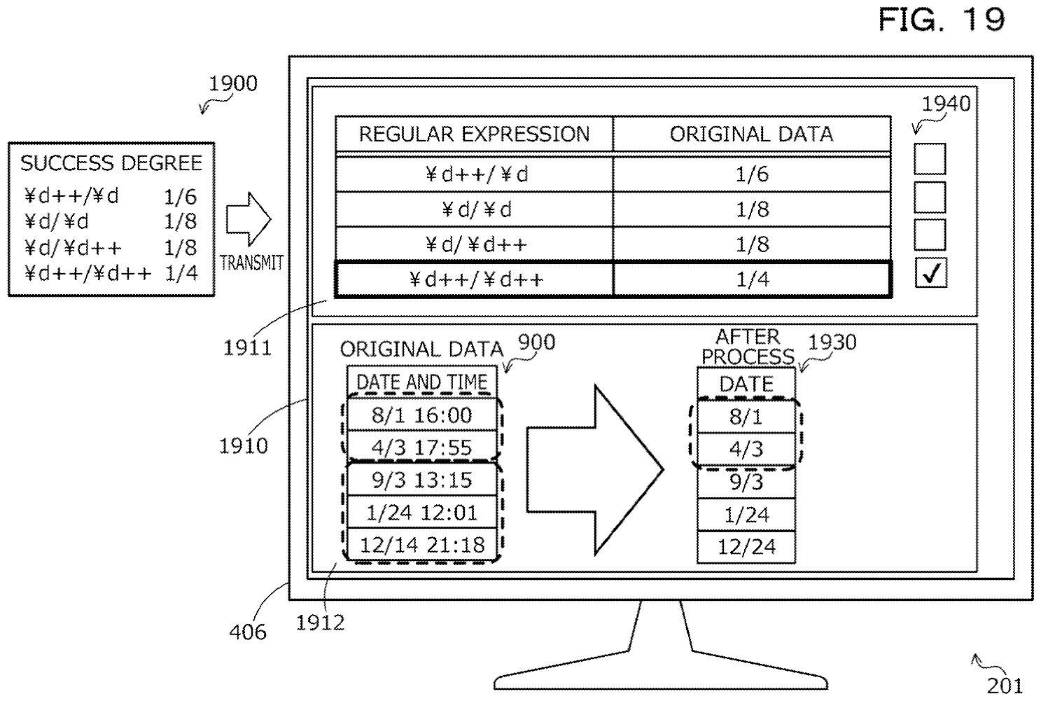

Furthermore, the information processing device 100 may process the original data group 900 according to the user's intention using any one of regular expressions on the basis of the success degree of each regular expression. Furthermore, the information processing device 100 may generate a program that can process the original data group 900 according to the user's intention using any one of the regular expressions on the basis of the success degree of each regular expression. Next, description of FIG. 19 will be made, and a display screen example of the client device 201 in a case where the information processing device 100 displays the success degree of each regular expression on the client device 201 will be described.

(Display Screen Example of Client Device 201)

FIG. 19 is an explanatory diagram illustrating a display screen example on the client device 201. In FIG. 19, the information processing device 100 transmits a list 1900 of the success degrees of the respective regular expressions calculated in FIGS. 9 to 18 to the client device 201. Upon receiving the list 1900 of the success degrees of the respective regular expressions, the client device 201 displays a display screen 1910.

The client device 201 displays the list 1900 of the success degrees of the respective regular expressions and a checkbox 1940 used to accept selection of each regular expression on a display region 1911 of the display screen 1910. In the example in FIG. 19, the client device 201 accepts selection of the regular expression “ [symbol] d++/ [symbol] d++” on the basis of an operation input of the user.

Upon receiving the selection of the regular expression “ [symbol] d++/ [symbol] d++”, the client device 201 transmits the regular expression “ [symbol] d++/ [symbol] d++” to the information processing device 100. The information processing device 100 processes the original data group 900 using the regular expression “ [symbol] d++/ [symbol] d++” and transmits a processed data group 1930 in association with the original data group 900 to the client device 201. When receiving the processed data group 1930 in association with the original data group 900, the client device 201 displays the processed data group 1930 in association with the original data group 900 on a display region 1912 of the display screen 1910.

As a result, the information processing device 100 can easily determine which one of the regular expressions is used to process the original data group 900 by the user so that the original data group 900 can be processed according to the user's intention on the basis of the success degree of each regular expression. For example, the information processing device 100 can make it easier to determine a regular expression that can perform processing according to the user's intention for the original data 930, 940, and 950 with no label of the original data group 900.

For example, the information processing device 100 can display the success degree of each regular expression on the client device 201 and make the user grasp the success degree of each regular expression. Furthermore, the information processing device 100 can make the user be able to grasp the result of processing the original data group 900 using the regular expression selected by the user and can reduce the work amount.

Here, a case has been described where the information processing device 100 processes the original data group 900. However, the embodiment is not limited to this. For example, there may be a case where the client device 201 receives the original data group 900 from the information processing device 100 or stores the original data group 900 in advance so as to process the original data group 900.

In the above description, a case has been described where the information processing device 100 calculates a record evaluation value and calculates a success degree of a regular expression on the basis of a division number evaluation value, a distance evaluation value, and a position evaluation value. However, the embodiment is not limited to this. For example, there may be a case where the information processing device 100 calculates a record evaluation value and calculates a success degree of a regular expression on the basis of two evaluation values of the division number evaluation value, the distance evaluation value, and the position evaluation value. Furthermore, for example, there may be a case where the information processing device 100 regards any one of the division number evaluation value, the distance evaluation value, and the position evaluation value as a record evaluation value and calculates the success degree of the regular expression.

(Reception Processing Procedure)

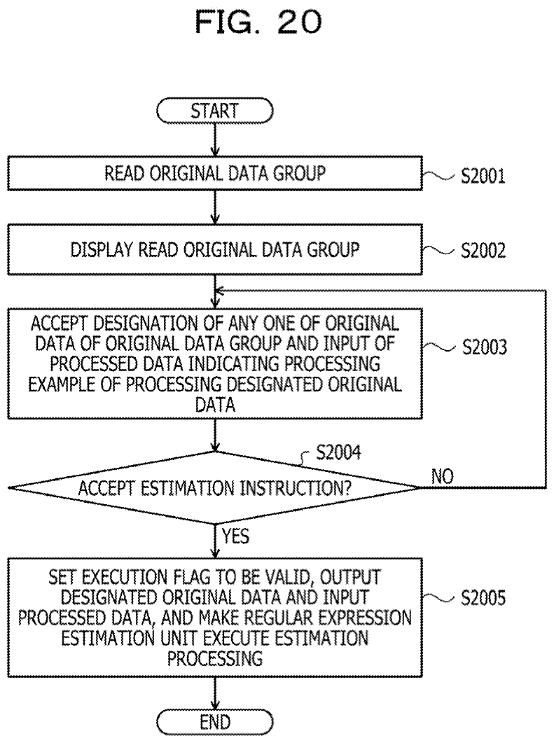

Next, an example of a reception processing procedure executed by the information processing device 100 will be described with reference to FIG. 20. Reception processing is implemented by, for example, the CPU 301, the storage region such as the memory 302 or the recording medium 305, and the network I/F 303 illustrated in FIG. 3.

FIG. 20 is a flowchart illustrating an example of a reception processing procedure. In FIG. 20, the original data display unit 610 reads an original data group (step S2001). Then, the original data display unit 610 displays the read original data group on the client device 201 (step S2002).

Next, the user input unit 620 accepts designation of any one piece of original data of the original data group and an input of processed data indicating a processing example of processing the designated original data from the client device 201 (step S2003). Then, the user input unit 620 determines whether or not an estimation instruction is accepted from the client device 201 (step S2004).

Here, in a case where the estimation instruction is not accepted (step S2004: No), the user input unit 620 returns to the processing in step S2003. On the other hand, in a case where the estimation instruction is accepted (step S2004: Yes), the user input unit 620 proceeds to processing in step S2005.

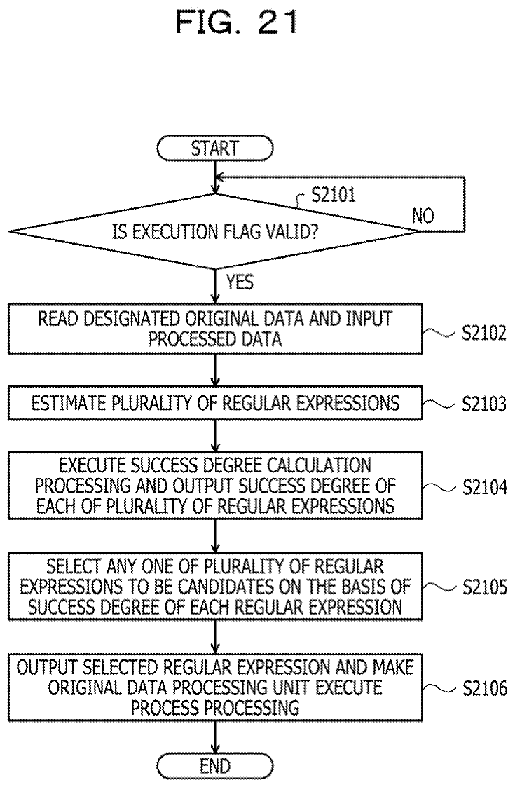

In step S2005, the user input unit 620 sets the execution flag of the regular expression estimation unit 630 to be valid, outputs the designated original data and the input processed data to the regular expression estimation unit 630, and makes the regular expression estimation unit 630 execute estimation processing described later with reference to FIG. 21 (step S2005). Then, the information processing device 100 ends the reception processing. As a result, the information processing device 100 can acquire various types of information used to generate the plurality of regular expressions and can use various types of information for the estimation processing described later with reference to FIG. 21.

(Estimation Processing Procedure)

Next, an example of an estimation processing procedure executed by the information processing device 100 will be described with reference to FIG. 21. The estimation processing is implemented by, for example, the CPU 301, the storage region such as the memory 302 or the recording medium 305, and the network I/F 303 illustrated in FIG. 3.

FIG. 21 is a flowchart illustrating an example of an estimation processing procedure. In FIG. 21, the regular expression estimation unit 630 determines whether or not the execution flag is valid (step S2101).

Here, in a case where the execution flag is not valid (step S2101: No), the regular expression estimation unit 630 returns to the processing in step S2101. On the other hand, in a case where the execution flag is valid (step S2101: Yes), the regular expression estimation unit 630 proceeds to processing in step S2102.

In step S2102, the regular expression estimation unit 630 reads the designated original data and the input processed data from the user input unit 620 and outputs the data to the candidate estimation unit 631 (step S2102). Then, the candidate estimation unit 631 estimates a plurality of regular expressions to be candidates used to process the original data group and outputs the estimated regular expressions to the success degree calculation unit 632 (step S2103).

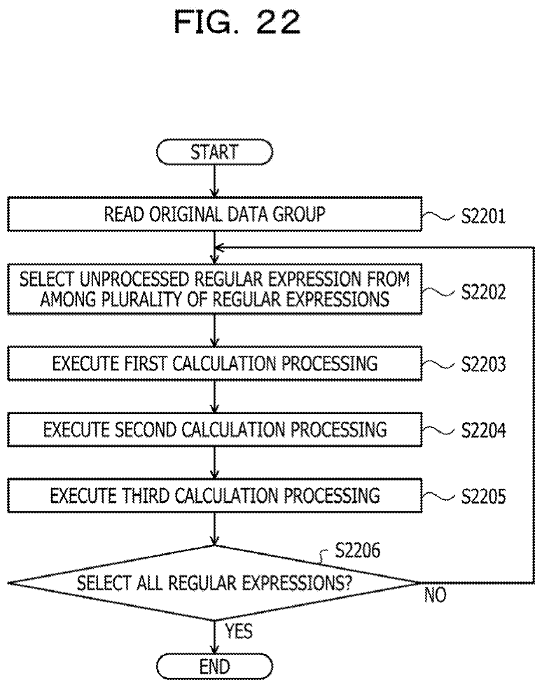

Next, the success degree calculation unit 632 executes success degree calculation processing to be described later with reference to FIG. 22 and outputs the success degree of each of the plurality of regular expressions to the regular expression selection unit 633 (step S2104). Then, the regular expression selection unit 633 selects any one of the plurality of regular expressions to be candidates on the basis of the success degree of each regular expression (step S2105).

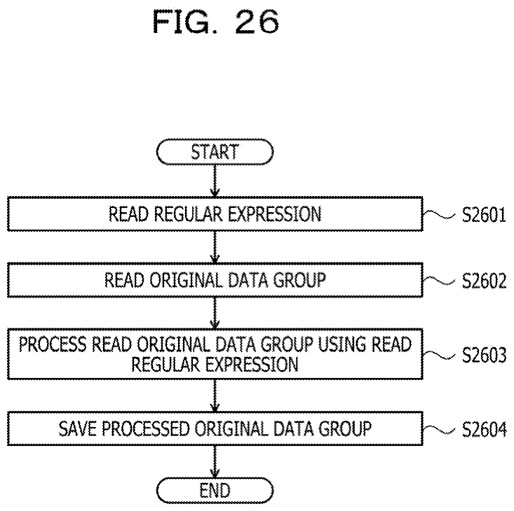

Next, the regular expression selection unit 633 outputs the selected regular expression to the original data processing unit 640 and makes the original data processing unit 640 execute process processing to be described later with reference to FIG. 26 (step S2106). Then, the information processing device 100 ends the estimation processing. As a result, the information processing device 100 estimates the plurality of regular expressions to be candidates used to process the original data group and makes it possible to use the plurality of regular expressions to process the original data group in the process processing to be described later with reference to FIG. 26.

(Success Degree Calculation Processing Procedure)

Next, an example of a success degree calculation processing procedure executed by the information processing device 100 will be described with reference to FIG. 22. The success degree calculation processing is implemented by, for example, the CPU 301, the storage region such as the memory 302 or the recording medium 305, and the network I/F 303 illustrated in FIG. 3.

FIG. 22 is a flowchart illustrating an example of the success degree calculation processing procedure. In FIG. 22, the success degree calculation unit 632 reads an original data group (step S2201). Then, the success degree calculation unit 632 selects a regular expression that is unprocessed from among the plurality of regular expressions to be candidates (step S2202).

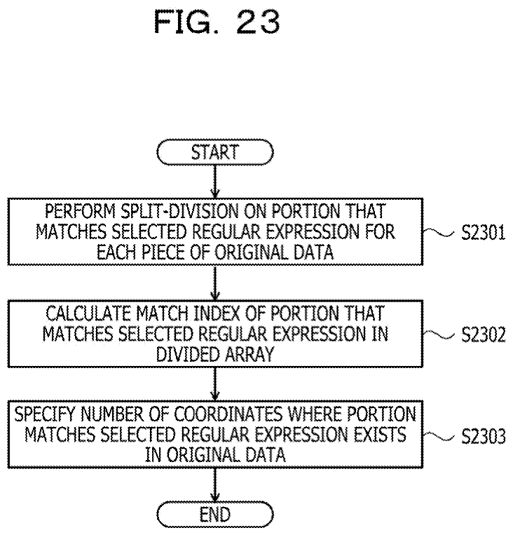

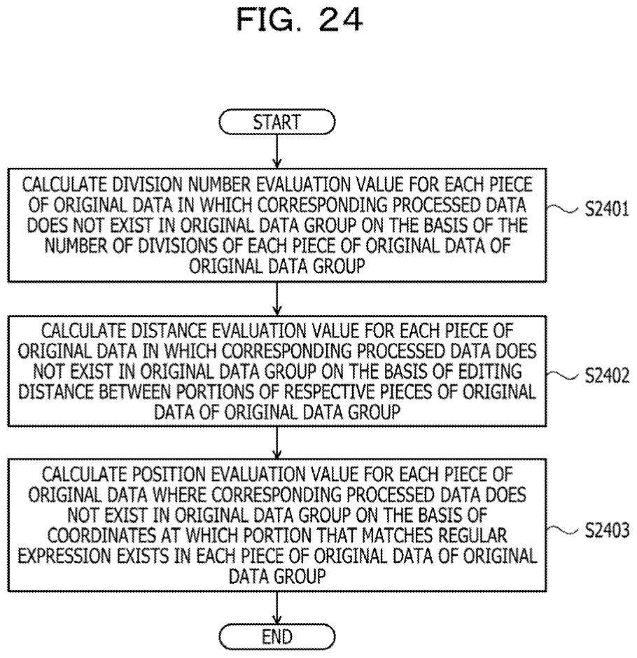

Next, the success degree calculation unit 632 executes first calculation processing to be described later with reference to FIG. 23 (step S2203). Then, the success degree calculation unit 632 executes second calculation processing to be described later with reference to FIG. 24 (step S2204).

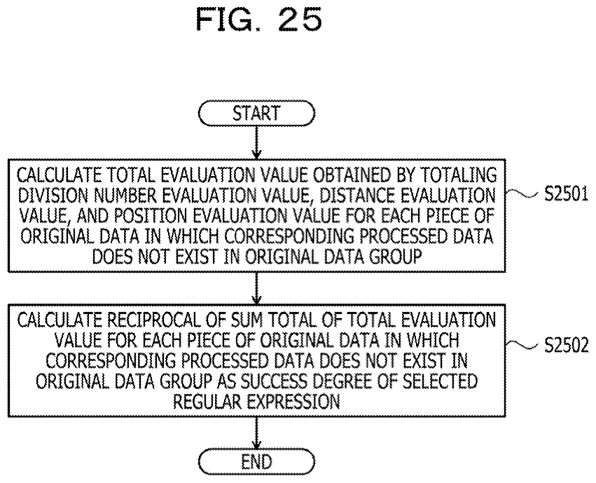

Next, the success degree calculation unit 632 executes third calculation processing to be described later with reference to FIG. 25 (step S2205). Then, the success degree calculation unit 632 determines whether or not all of the plurality of regular expressions to be candidates are selected (step S2206).

Here, in a case where there is a regular expression that has not been selected yet (step S2206: No), the success degree calculation unit 632 returns to the processing in step S2202. On the other hand, in a case where all the regular expressions are selected (step S2206: Yes), the information processing device 100 ends the success degree calculation processing. As a result, the information processing device 100 can calculate the success degree of each regular expression and can refer to which regular expression has a high probability that the original data group can be processed according to the user's intention.

(First Calculation Processing Procedure)

Next, an example of a first calculation processing procedure executed by the information processing device 100 will be described with reference to FIG. 23. The first calculation processing is implemented by, for example, the CPU 301, the storage region such as the memory 302 or the recording medium 305, and the network I/F 303 illustrated in FIG. 3.

FIG. 23 is a flowchart illustrating an example of the first calculation processing procedure. In FIG. 23, the success degree calculation unit 632 performs split-division on a portion that matches the selected regular expression for each piece of the original data (step S2301). Then, the success degree calculation unit 632 calculates a match index of the portion that matches the selected regular expression in the divided array (step S2302).

Next, the success degree calculation unit 632 specifies the number of coordinate where the portion matches the selected regular expression exists in the original data (step S2303). Then, the information processing device 100 ends the first calculation processing.

(Second Calculation Processing Procedure)

Next, an example of a second calculation processing procedure executed by the information processing device 100 will be described with reference to FIG. 24. The second calculation processing is implemented by, for example, the CPU 301, the storage region such as the memory 302 or the recording medium 305, and the network I/F 303 illustrated in FIG. 3.

FIG. 24 is a flowchart illustrating an example of the second calculation processing procedure. In FIG. 24, the success degree calculation unit 632 calculates a division number evaluation value for each piece of original data in which the corresponding processed data does not exist in the original data group on the basis of the number of divisions of each piece of the original data of the original data group (step S2401).

Next, the success degree calculation unit 632 calculates a distance evaluation value for each piece of the original data in which the corresponding processed data does not exist in the original data group on the basis of the editing distance between the original data portions of the original data group (step S2402).

Next, the success degree calculation unit 632 calculates a position evaluation value for each piece of the original data where the corresponding processed data does not exist in the original data group on the basis of the coordinates at which the portion that matches the regular expression exists in each piece of original data of the original data group (step S2403). Then, the information processing device 100 ends the second calculation processing.

(Third Calculation Processing Procedure)

Next, an example of a third calculation processing procedure executed by the information processing device 100 will be described with reference to FIG. 25. The third calculation processing is implemented by, for example, the CPU 301, the storage region such as the memory 302 or the recording medium 305, and the network I/F 303 illustrated in FIG. 3.

FIG. 25 is a flowchart illustrating an example of the third calculation processing procedure. In FIG. 25, the success degree calculation unit 632 calculates a total evaluation value obtained by totaling the division number evaluation value, the distance evaluation value, and the position evaluation value for each piece of the original data in which the corresponding processed data does not exist in the original data group (step S2501).

Next, the success degree calculation unit 632 calculates a reciprocal of the sum total of the total evaluation value for each piece of the original data in which the corresponding processed data does not exist in the original data group as the success degree of the selected regular expression (step S2502). Then, the information processing device 100 ends the third calculation processing.

(Process Processing Procedure)

Next, an example of a process processing procedure executed by the information processing device 100 will be described with reference to FIG. 26. The process processing is, for example, implemented by the CPU 301, the storage region such as the memory 302 or the recording medium 305, and the network I/F 303 illustrated in FIG. 3.

FIG. 26 is a flowchart illustrating an example of the process processing procedure. In FIG. 26, the original data processing unit 640 reads a regular expression from the regular expression selection unit 633 (step S2601).

Next, the original data processing unit 640 reads an original data group (step S2602). Then, the original data processing unit 640 processes the read original data group using the read regular expression (step S2603).

Next, the original data processing unit 640 saves the processed original data group (step S2604). Then, the information processing device 100 ends the process processing. As a result, the information processing device 100 can automatically process the original data group and reduce the work amount of the user than a case where the user manually processes the original data group.

Here, the information processing device 100 may shuffle processing of some steps in each of the flowcharts in FIGS. 20 to 26 and execute the processing. For example, orders of processing in steps S2301 to S2303 can be shuffled. Furthermore, the information processing device 100 may omit processing in some steps in each of the flowcharts in FIGS. 20 to 26. For example, the processing in any of steps S2401 to S2403 may be omitted.

As described above, according to the information processing device 100, the plurality of regular expressions that can be used to search each piece of the data of the data group for the portion to be processed can be acquired. According to the information processing device 100, the likelihood of using each regular expression for the processing of the data group can be calculated on the basis of the portion corresponding to each of the plurality of acquired regular expressions in each piece of the data of the data group. According to the information processing device 100, the calculated likelihood of each regular expression can be output. This makes it possible for the information processing device 100 to determine which regular expression is preferable for the processing of the data group. Therefore, the information processing device 100 can process the data group according to the user's intention using any one of regular expressions. Furthermore, the information processing device 100 can reduce the work amount of the user.

The information processing device 100 can calculate the likelihood of the regular expression on the basis of the number of pieces of partial data divided from each piece of the data of the data group in a case where each piece of the data of the data group is divided with reference to the portion corresponding to the regular expression for each regular expression. As a result, the information processing device 100 can improve accuracy of calculating the likelihood from the regularity that appears regarding the number of pieces of partial data divided from each piece of the data of the data group.

According to the information processing device 100, it is possible to acquire the plurality of regular expressions generated on the basis of the one or more pieces of data included in the data group and the data indicating the processing example of each of the one or more pieces of data. According to the information processing device 100, for each regular expression, it is possible to compare the number of pieces of partial data divided from each of the one or more pieces of data and the number of pieces of partial data divided from each piece of the remaining data. According to the information processing device 100, it is possible to calculate the likelihood of the regular expression on the basis of the comparison result. As a result, the information processing device 100 can set the regularity that appears regarding the one or more pieces of data used to generate the plurality of regular expressions and that is determined to have a high probability of reflecting the user's intention as a reference of calculating the likelihood and can improve the accuracy of calculating the likelihood.

According to the information processing device 100, for each regular expression, it is possible to select the first partial data and the second partial data from among the pieces of partial data divided with reference to the portion corresponding to the regular expression from each piece of the data of the data group. According to the information processing device 100, the likelihood of the regular expression can be calculated on the basis of the similarity between the selected first partial data and second partial data. As a result, the information processing device 100 can improve the accuracy of calculating the likelihood from the regularity that appears regarding the similarity between the first partial data and the second partial data.

According to the information processing device 100, it is possible to acquire the plurality of regular expressions generated on the basis of the one or more pieces of data included in the data group and the data indicating the processing example of each of the one or more pieces of data. According to the information processing device 100, for each regular expression, it is possible to select the first partial data from among the pieces of partial data divided from each of the one or more pieces of data. According to the information processing device 100, it is possible to select the second partial data that exists at the position corresponding to the first partial data from among the pieces of partial data divided from each piece of the data of the remaining data. According to the information processing device 100, for each regular expression, it is possible to calculate the likelihood of the regular expression on the basis of the similarity between the selected first partial data and the selected second partial data. As a result, the information processing device 100 can set the regularity that appears regarding the one or more pieces of data used to generate the plurality of regular expressions and that is determined to have a high probability of reflecting the user's intention as a reference of calculating the likelihood and can improve the accuracy of calculating the likelihood.

According to the information processing device 100, the similarity can be expressed by the editing distance between the first partial data and the second partial data. As a result, the information processing device 100 can calculate a similarity between the first partial data and the second partial data.

The information processing device 100 can calculate the likelihood of the regular expression on the basis of the position where the portion corresponding to the regular expression exists in each piece of the data of the data group, for each regular expression. As a result, the information processing device 100 can improve the accuracy of calculating the likelihood from the regularity that appears regarding the position where the portion corresponding to the regular expression exists in each piece of the data of the data group.

According to the information processing device 100, it is possible to acquire the plurality of regular expressions generated on the basis of the one or more pieces of data included in the data group and the data indicating the processing example of each of the one or more pieces of data. According to the information processing device 100, for each regular expression, it is possible to compare the position where the portion corresponding to the regular expression exists in each of the one or more pieces of data and the position where the portion corresponding to the regular expression exists in each piece of the remaining data. According to the information processing device 100, it is possible to calculate the likelihood of the regular expression on the basis of the comparison result. As a result, the information processing device 100 can set the regularity that appears regarding the one or more pieces of data used to generate the plurality of regular expressions and that is determined to have a high probability of reflecting the user's intention as a reference of calculating the likelihood and can improve the accuracy of calculating the likelihood.

The information processing device 100 can calculate the likelihood of the regular expression on the basis of the number of portions corresponding to the regular expression in each piece of the data of the data group, for each regular expression. As a result, the information processing device 100 can improve the accuracy of calculating the likelihood from the regularity that appears regarding the number of portions corresponding to the regular expression in each piece of the data of the data group.

According to the information processing device 100, it is possible to select any one of the plurality of regular expressions on the basis of the calculated likelihood of each regular expression and process and output the data group using the selected one of the regular expressions. As a result, the information processing device 100 can improve a probability of being processed according to the user's intention when the data group is automatically processed. Furthermore, the information processing device 100 can reduce the work amount of the user than a case where the user manually processes the data group.

According to the information processing device 100, it is possible to generate the plurality of regular expressions on the basis of the one or more pieces of data included in the data group and the data indicating the processing example of each of the one or more pieces of data. As a result, the information processing device 100 can automatically generate the plurality of regular expressions. Therefore, the information processing device 100 can reduce the work amount of the user by causing the user not to need to generate the plurality of regular expressions.

Note that the information processing method described in the present embodiment may be implemented by executing a prepared program on a computer such as a personal computer or a workstation. The information processing program described in the present embodiment is recorded on a computer-readable recording medium such as a hard disk, flexible disk, compact disk read only memory (CD-ROM), magneto-optical disk (MO), or digital versatile disc (DVD), and is read from the recording medium to be executed by the computer. Furthermore, the information processing program described in the present embodiment may be distributed via a network such as the Internet.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory computer-readable recording medium storing an information processing program for causing a computer to execute processing comprising:
acquiring a plurality of regular expressions that is able to be used to search for a portion to be processed from each piece of data of a data group that is generated on the basis of the data included in the data group and data that indicates a processing example of the data;
calculating a likelihood of using each regular expression to process the data group on the basis of a portion that corresponds to each of the plurality of acquired regular expressions in each piece of the data of the data group; and
outputting the calculated likelihood of each of the regular expressions.

2. The non-transitory computer-readable recording medium storing the information processing program according to claim 1, wherein
the calculating processing
calculates the likelihood of the regular expression on the basis of the number of pieces of partial data divided from each piece of the data of the data group in a case where each piece of the data of the data group is divided with reference to the portion that corresponds to the regular expression, for each regular expression.

3. The non-transitory computer-readable recording medium storing the information processing program according to claim 2, wherein
the plurality of regular expressions is generated on the basis of one or more pieces of data included in the data group and data that indicates a processing example of each of the one or more pieces of data, and
the calculating processing
calculates the likelihood of the regular expression on the basis of a result of comparing the number of pieces of partial data divided from each of the one or more pieces of data and the number of pieces of partial data divided from each piece of remaining data that excludes the one or more pieces of data included in the data group in a case where each piece of the data of the data group is divided with reference to the portion that corresponds to the regular expression, for each regular expression.

4. The non-transitory computer-readable recording medium storing the information processing program according to claim 1, wherein
the calculating processing
calculates the likelihood of the regular expression on the basis of a similarity between first partial data and second partial data selected from among the pieces of partial data divided from each piece of the data of the data group in a case where each piece of the data of the data group is divided with reference to the portion that corresponds to the regular expression, for each regular expression.

5. The non-transitory computer-readable recording medium storing the information processing program according to claim 4, wherein
the plurality of regular expressions is generated on the basis of one or more pieces of data included in the data group and data that indicates a processing example of each of the one or more pieces of data, and
the calculating processing
calculates the likelihood of the regular expression on the basis of a similarity between first partial data selected from among pieces of partial data divided from each of the one or more pieces of data and second partial data that is selected from among pieces of partial data divided from each piece of the remaining data that excludes the one or more pieces of data included in the data group and exists at a position that corresponds to the first partial data in a case where each piece of the data of the data group is divided with reference to the portion that corresponds to the regular expression, for each regular expression.

6. The non-transitory computer-readable recording medium storing the information processing program according to claim 4, wherein the similarity is expressed by an editing distance between the first partial data and the second partial data.

7. The non-transitory computer-readable recording medium storing the information processing program according to claim 1, wherein
the calculating processing
calculates the likelihood of the regular expression on the basis of a position where the portion that corresponds to the regular expression exists in each piece of the data of the data group, for each regular expression.

8. The non-transitory computer-readable recording medium storing the information processing program according to claim 7, wherein
the plurality of regular expressions is generated on the basis of one or more pieces of data included in the data group and data that indicates a processing example of each of the one or more pieces of data, and
the calculating processing
calculates the likelihood of the regular expression on the basis of a result of comparing a position where the portion that corresponds to the regular expression exists in each of the one or more pieces of data and a position where the portion that corresponds to the regular expression exists in each piece of the data of the remaining data that excludes the one or more pieces of data included in the data group, for each regular expression.

9. The non-transitory computer-readable recording medium storing the information processing program according to claim 1, wherein
the calculating processing
calculates the likelihood of the regular expression on the basis of the number of portions that correspond to the regular expression in each piece of the data of the data group, for each regular expression.

10. The non-transitory computer-readable recording medium storing the information processing program according to claim 1, for causing the computer to execute processing further comprising:
selecting any one of the plurality of regular expressions on the basis of the calculated likelihood of each regular expression; and
processing and outputting the data group using the selected one of the regular expressions.

11. The non-transitory computer-readable recording medium storing the information processing program according to claim 1, wherein
the acquiring processing
generates the plurality of regular expressions on the basis of one or more pieces of data included in the data group and data that indicates a processing example of each of the one or more pieces of data.

12. An information processing method comprising:
acquiring, by a computer, a plurality of regular expressions that is able to be used to search for a portion to be processed from each piece of data of a data group that is generated on the basis of the data included in the data group and data that indicates a processing example of the data;
calculating a likelihood of using each regular expression to process the data group on the basis of a portion that corresponds to each of the plurality of acquired regular expressions in each piece of the data of the data group; and
outputting the calculated likelihood of each of the regular expressions.

13. An information processing comprising:
a memory; and
a processor coupled to the memory and configured to:
acquire a plurality of regular expressions that is able to be used to search for a portion to be processed from each piece of data of a data group that is generated on the basis of the data included in the data group and data that indicates a processing example of the data;
calculate a likelihood of using each regular expression to process the data group on the basis of a portion that corresponds to each of the plurality of acquired regular expressions in each piece of the data of the data group; and
output the calculated likelihood of each of the regular expressions.
